(19) United States
(12) Patent Application Publication
(10) Pub. No.: US 2015/0205297 A1
(43) Pub. Date: Jul. 23, 2015

(54) INFRASTRUCTURE FOR ROBOTS IN HUMAN-CENTRIC ENVIRONMENTS

(71) Applicant: RoboteX Inc., Sunnyvale, CA (US)

(72) Inventors: Andrew G. STEVENS, Palo Alto, CA (US); Adam M. GETTINGS, Red Wing, MN (US)

(73) Assignee: RoboteX Inc., Sunnyvale, CA (US)

(21) Appl. No.: 14/676,431

(22) Filed: Apr. 1, 2015

Related U.S. Application Data
(63) Continuation of application No. PCT/US2013/066695, filed on Oct. 24, 2013.
(60) Provisional application No. 61/718,019, filed on Oct. 24, 2012.

(51) Int. Cl. G05D 1/00; G01S 1/70; G01S 1/72; G05D 1/02; G01S 1/68

(52) U.S. Cl. CPC G05D 1/0022; G05D 1/028; G01S 1/68; G01S 1/725; G01S 1/70

(57) ABSTRACT

To improve efficient use of robots in human-centric environments, robots have to overcome a number of challenges, including mobility challenges, physical interface challenges, self-maintenance challenges, security challenges, and safety challenges. These challenges can be overcome either by adding technology to a robot or by adding infrastructure to a robot's environment.

### CROSS-REFERENCE TO RELATED APPLICATION

The present application is a continuation of PCT International Patent Application No. PCT/US2013/066695 filed Oct. 24, 2013, which claims priority to U.S. Provisional App. No. 61/718,019, filed Oct. 24, 2012, both of which are herein incorporated by reference in its entirety.

### TECHNICAL FIELD

This invention relates generally to the robotics field and more specifically to new and useful infrastructure for mobile robots.

### BACKGROUND

There is tremendous complexity and a number of challenges in operating robots in human-centric environments, e.g. office buildings, factories, and homes. Human functionality is difficult to replicate in robots.

Thus, there is a need in the robotics field to create new infrastructure for robots in human-centric environments. New infrastructure for such purposes is desired.

Robots in human-centric environments often have to overcome a number of challenges, including mobility challenges, physical interface challenges, self-maintenance challenges, security challenges, and safety challenges. These challenges can be overcome either by adding technology to a robot or by adding infrastructure to a robot's environment. Adding infrastructure to a robot's environment can be a one-time and/or incremental capital investment that can be amortized over many years and can support future upgrades as robot and sensor technologies evolve, possibly allowing multiple product generations of robots to be used simultaneously. Temporary and semi-permanent installations can be used for short-term deployments such as construction sites, rock concerts, sporting events, etc.

### SUMMARY OF THE INVENTION

Two of the major challenges faced by robots are mobility and sustainability. Mobility challenges can be solved by building infrastructure which can include buildings that can have door openers, special entrances, systems or structures for the robot to interact with that assist the robot to traverse between floors, navigation markers, and machine-readable tags. Mobility challenges can be solved by physical or virtual (software) enhancements to the robot, including mobility assistance devices, improved power management systems, card access systems, manipulator arms, sensors (optical, sonic, mechanical, etc.) and any other suitable robotic enhancements. Sustainability challenges, which can relate to keeping a robot operating in a continuous, self-sustaining mode (such that they may or may not require human maintenance/assistance to operate), can be solved by physical enhancements to the robot and/or building infrastructure, which can include charging stations, accessory changing stations, storage stations, security patrol stations/checkpoints, data transferring stations, repair stations, arming stations, waste removal stations, and cleaning stations.

A robot beacon navigation system is disclosed. The system can include a building that has at least two robot navigation beacons and/or tags at different locations in the building. The building can have three or more beacons and/or tags. The system can have a server. The system can have a mobile robot configured to wirelessly communicate directly or indirectly with the server. The robot can be configured to receive a signal from the beacons and/or tags. The robot can be configured to send the signal received from the beacons and/or tags to the server. The server can be configured to send instruction data to the robot in response to the signal received from at least one of the beacons and/or tags.

A method of controlling a mobile robot is disclosed. The method can include positioning the robot in a building have two, three, or more robot navigation beacons and/or tags at different locations in the building. The method can include transmitting beacon data from the beacons and/or tags to the robot. The method can include transmitting robot data from the robot to a server. At least a portion of the robot data can include at least some of the beacon data. transmitting instruction data from the server to the robot.

A method of moving a robot through a doorway is disclosed. The method can include closing a door in the doorway. The door can have an upper partition and a lower partition. The method also can include opening the lower partition with the robot while the upper partition remains closed. The method can also include traversing the doorway with the robot.

A door is disclosed. The door can have an upper partition and a rigid lower partition. The lower partition can be configured to rotate with respect to the upper partition. The door can have an actuator configured to unlock the lower partition, wherein the actuator is configured to be activated by a mobile robot.

### BRIEF DESCRIPTION OF THE FIGURES

FIGS. 1a and 1b are simplified views of a variation of the robotic system with the utility arm in retracted and extended configurations, respectively.

FIGS. 1c and 1d are simplified views of a variation of the robotic system with the utility arm in various orientations. The utility arm is shown twice in both figures to illustrate its rotation.

FIGS. 2a through 2c are partial views of variations of the robotic system with the utility arm in an extended configuration.

FIGS. 3a and 3b illustrate a variation of the three-pronged gripping device in the closed and open configurations, respectively.

FIGS. 4a and 4b illustrate a variation of the robotic system with the hooked arm in various configurations.

FIG. 5 illustrates a variation of the building with automatic door openers.

FIGS. 6a through 6d illustrate variations of a building with door adapters in an external configuration. FIG. 6d is a cross-sectional view taken along the line X-X in FIG. 6a and illustrates a variation of a building with door adapters in an internal configuration.

FIG. 7a illustrates a variation of a building with robot door pulls. FIG. 7b is an alternate view of the building with variations of the robot door pull.

FIGS. 8a and 8b illustrate a variation of a building with robot doors embedded in existing doors.

FIGS. 8c through 8g are variations of cross-sectional views taken along the line X-X in FIG. 8a and illustrate variations of the embedded robot door.

FIG. 8h is a variation of cross-sectional view taken along the line Y-Y in FIG. 8a and illustrates a variation of the embedded robot door.

FIGS. 9a and 9b illustrate a variation of a building with half doors having latches in external and internal configurations, respectively.

FIG. 9c is a variation of a building with half doors.

FIGS. 10a and 10b illustrate a variation of a building with separate robot doors.

FIGS. 10c through 10g are cross-sectional views taken of a variation along the line X-X in FIG. 10a and illustrate variations of the separate robot door.

FIG. 10h is a cross-sectional view of a variation of a taken along the line Y-Y in FIG. 10a and illustrates a variation of the separate robot door.

FIGS. 11a and 11b illustrate a variation of a building with robot ramps and elevators.

FIGS. 12a and 12b illustrate a variation of a building with one-way glass embedded in floor and ceiling tiles, respectively.

FIG. 13a illustrates a variation of a building with robot cargo nets.

FIGS. 13b and 13c are views of a variation of a building with variations of robot cargo nets.

FIG. 14 illustrates a variation of the robotic system including tracks with climb assisting features.

FIG. 15a illustrates a variation of the building with track systems.

FIGS. 15b through 15d are views of variations of the building and variations of the track system for both internal and external use on a building.

FIGS. 16a and 16c illustrate variations of a building with robot ramps between floors.

FIG. 17a illustrates a variation of a building equipped with various robot navigation beacons and machine-readable tags.

FIGS. 17a-1a, 17a-1b, 17a-2a, and 17a-2b illustrate a variation of a robot equipped with variations of navigation beacon detectors.

FIG. 17b illustrates a variation of a robot equipped with devices capable of reading machine-readable tags.

FIG. 18 illustrates a variation of the robot charging station.

FIG. 19a illustrates a variation of the building with the robot accessory changing station.

FIG. 19b is an alternate view of the building with a variation of the robot accessory changing station.

FIG. 20 is a schematic view of a variation of components in a robot navigation beacon.

### DETAILED DESCRIPTION

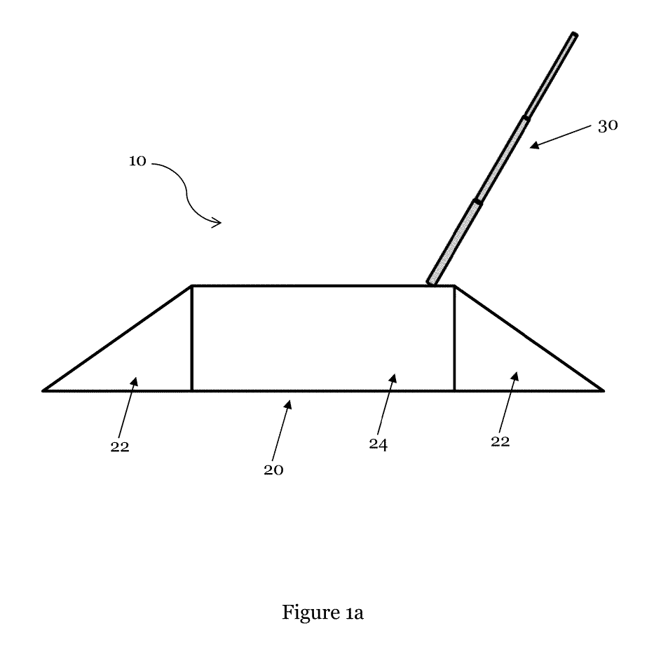

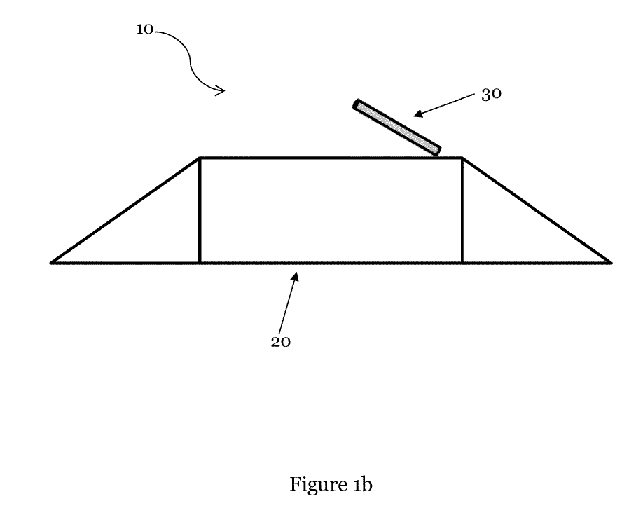

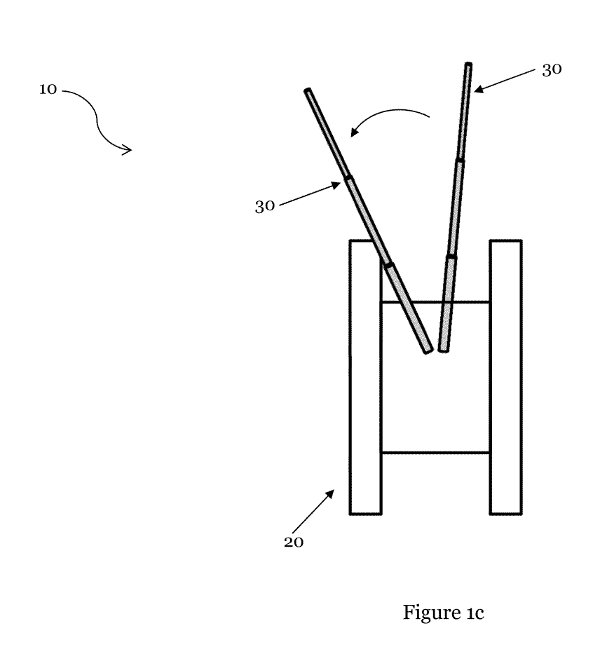

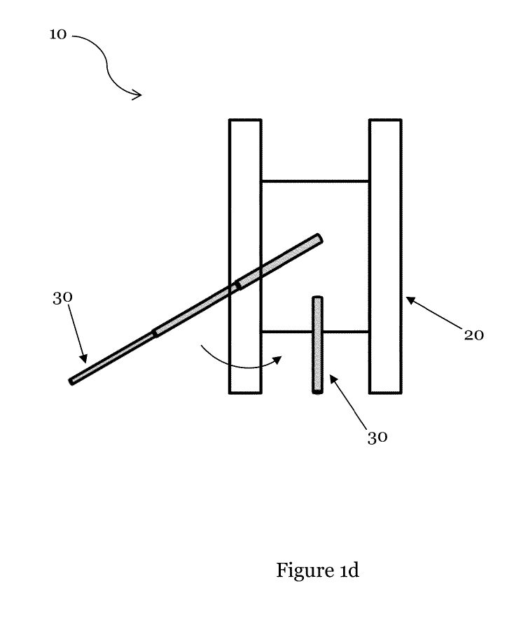

As shown in FIG. 1, a robotic system 10 can be equipped with a utility elongated rod, bar, or arm 30. The robot system 10 can have a robot 20. The robot 20 can have a body 24. The robot 20 can have one or more front and rear flippers 22 having tracks and rotatably extending longitudinally away from the center of the body 24.

As shown in FIGS. 1a and 1b, the utility arm 30 can be telescoping and can be extended and retracted using an actuator, hydraulics, piezos, or any other suitable method of extending or retracting the arm 30. The arm 30 can swivel on its base (i.e., where the arm connects to the body 24) to change the orientation of the utility arm 30 with respect to the robot 20 and can rotate about the longitudinal axis of the arm 30 to change the orientation of any devices attached to the arm 30.

As shown in FIGS. 1c and 1d, the utility bar 30 can be rotated (as shown by arrows) to manipulate (e.g., rotate and translate) objects in front of, behind, and on either side of the robot 20 and can be raised and lowered to manipulate objects at various heights. The utility arm 30 can be used to manipulate objects in the environment; for example, in a human-centric environment the arm 30 can be used to open doors, operate door-opening mechanisms, turn off light switches, push elevator buttons, and/or perform any other suitable function. The utility arm 30 can be made of hard plastic, steel, aluminum, carbon fiber, or combinations thereof.

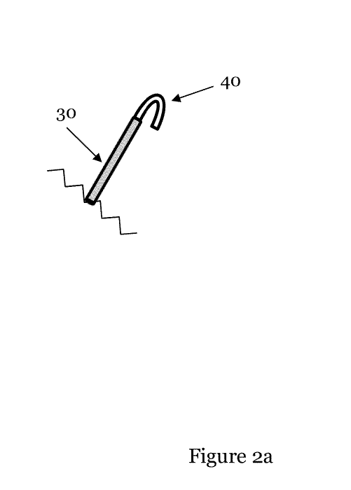

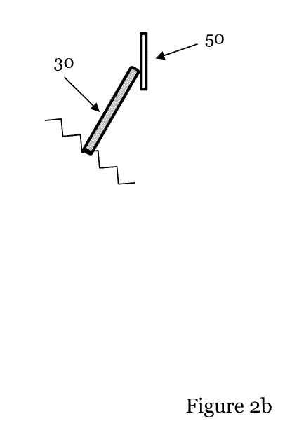

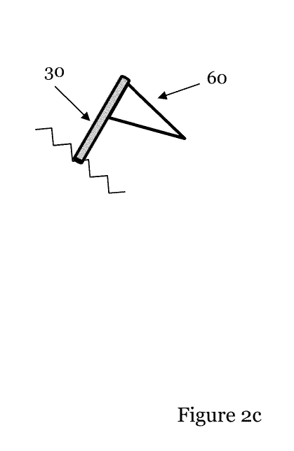

As shown in FIGS. 2a, 2b, and 2c, a utility arm 30 can be equipped with one or more attachments that can provide additional functionality to the utility arm 30. As shown in FIG. 2a, the attachment can include a manipulator device 40, which can be used to manipulate objects in the environment; for example, in a human-centric environment the manipulating device 40 can be a hook and can be used to pull down on door handles, move furniture, unplug devices, type on a keyboard, pull a fire alarm, tow payloads, deliver dry cleaning, or combinations thereof.

As shown in FIG. 2b, the attachment can include an access card or other key device 50, which can be used to gain entry into controlled access areas. The robot system 10 can be configured to physically swipe the key device 50 through a card reader or against a card reader (for example, similar to a “key fob” device). The key device 50 may be a “smart key” device, such that a radio pulse generator in the key is recognized by an antenna in the access system or building. The access system may automatically unlock the door upon the robot 20 entering the area with the key device 50 or upon the robot pressing a button or pulling a lever while holding the key device 50. The key device 50 may be built into the robot body 24 (e.g., not attached to the arm 30).

The identification card 50 can be configured to be disabled if removed from the utility arm 30, for example, to ensure that only certain robots have access to the controlled area. The access card or other key device 50 can be disabled when removed from the arm 30. For example, the access card 50 can stop working when cut off from its power source, which can be connected through the arm 30. The access card 50 can be disabled when removed from the proximity of a wireless authentication device, such as a Bluetooth device or a radio-frequency identification tag reader on a robot 20, or when cut off from a power supply on a robot 20, when removed from the proximity of a building, when removed from the proximity of a wireless network of a building, when cut off from a proximity sensor located on a robot 20, when cut off from a decryption key provided by a computer or electronic circuit on a robot 20, or combinations thereof.

As shown in FIG. 2c, the attachment can include an identifier, such as a flag or pennant 60, which can function to make humans aware of the robot, to identify and/or distinguish between robots having similar appearances, to differentiate between robots with different functionalities and features (e.g. cleaning robots and security robots), and to make the robot appear more human-friendly. For example, a human following up with a robot 20 at an event site can more easily distinguish robots by a number, name, color, or other identifier on a pennant 60. The pennant 60 can be made of fabric, plastic, paper, rubber, or any other suitable material. A robot can also change the flag or pennants as the robot switches functionality (e.g., a security-indicating pennant when the robot is in a security mode, and a delivery-indicating pennant when the robot is in a delivery mode). An mobile device, such as a mobile phone, portable television, or tablet computer or laptop computer can be attached to the robot and can be used to identify the robot and provide 2-way communication with a user, operator, or other party (e.g., through the mobile device) that may be interfacing with the robot's environment.

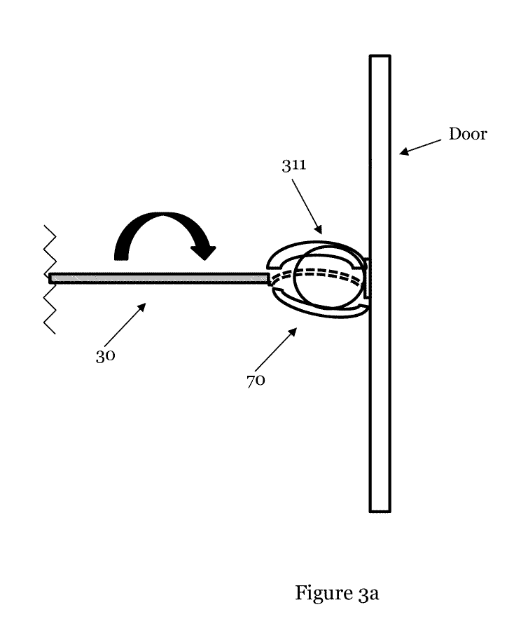

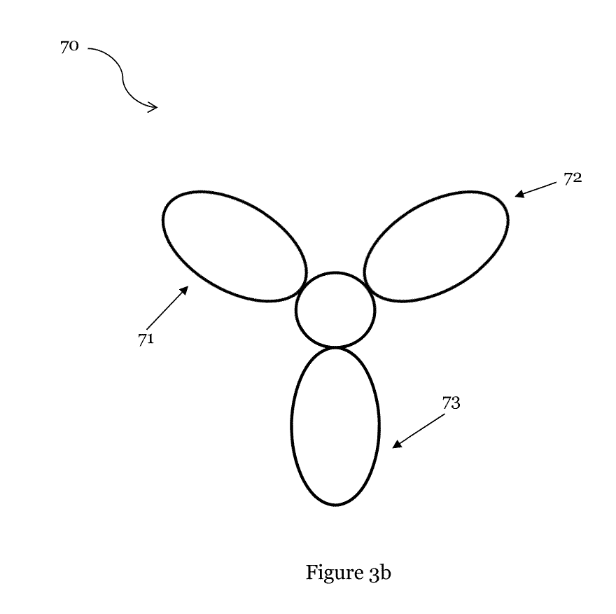

FIGS. 3a and 3b illustrate that the utility rod or arm 30 can be equipped with a gripping device 70. The gripping device 70 can be used to manipulate objects in a human-centric environment, e.g. open doors. The gripping device 70 can include three prongs 71, 72, and 73, as shown in FIG. 3b. The prongs can be curved prongs 71, 72, and 73, and can be concave and/or spoon-shaped, square-shaped, triangular, convex, hexagonal, mated to a specific door knob, handle, or interface, or combinations thereof. The gripping device 70 can be made of a rigid material. The prongs can include a layer of protective material such as rubber, felt, or combinations thereof, for example, to prevent the gripper 70 from damaging objects, and to prevent objects in the environment from damaging the gripper 70. The gripping device 70 can be opened, closed, and rotated about its own longitudinal axis using actuators, springs, or any other suitable method or combinations thereof for opening, closing, and twisting the gripping device 70. The gripping device 70 can be used to manipulate objects in the environment; for example, in a human-centric environment the gripper 70 can be used to pull down on door handles, twist door knobs 311, open containers, change light bulbs, operate water faucets, tighten and loosen screws, turn on lamps, change thermostat settings, reboot computers, install hot-swappable hard drives in a server, or combinations thereof.

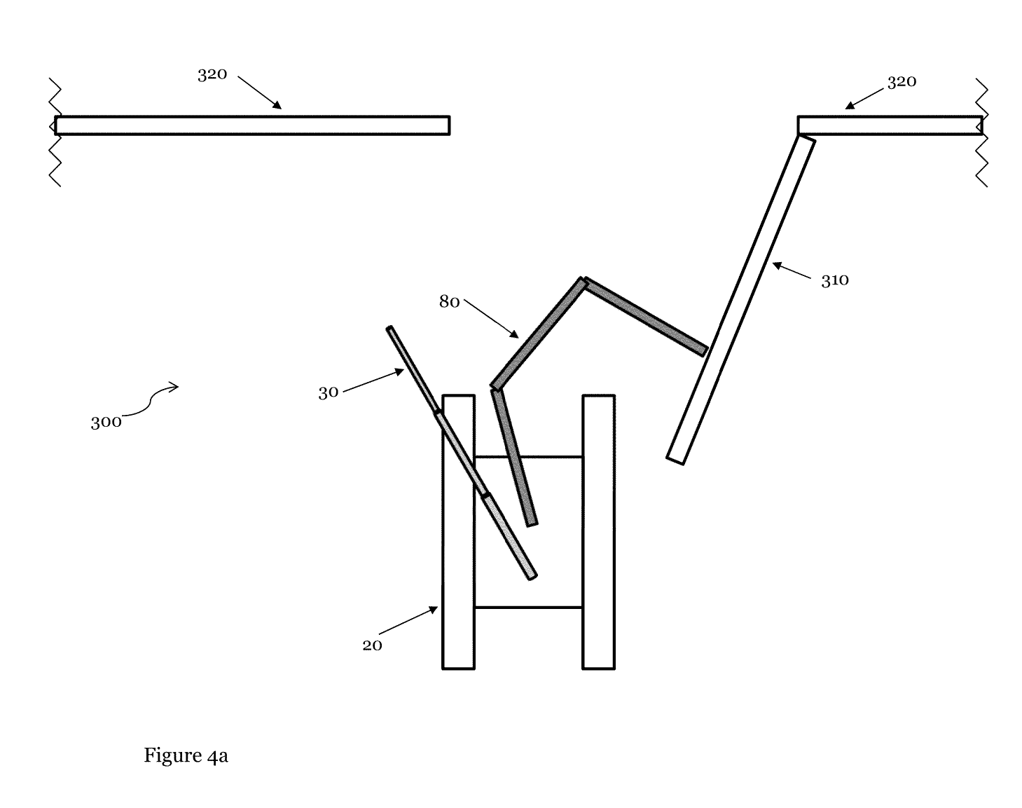

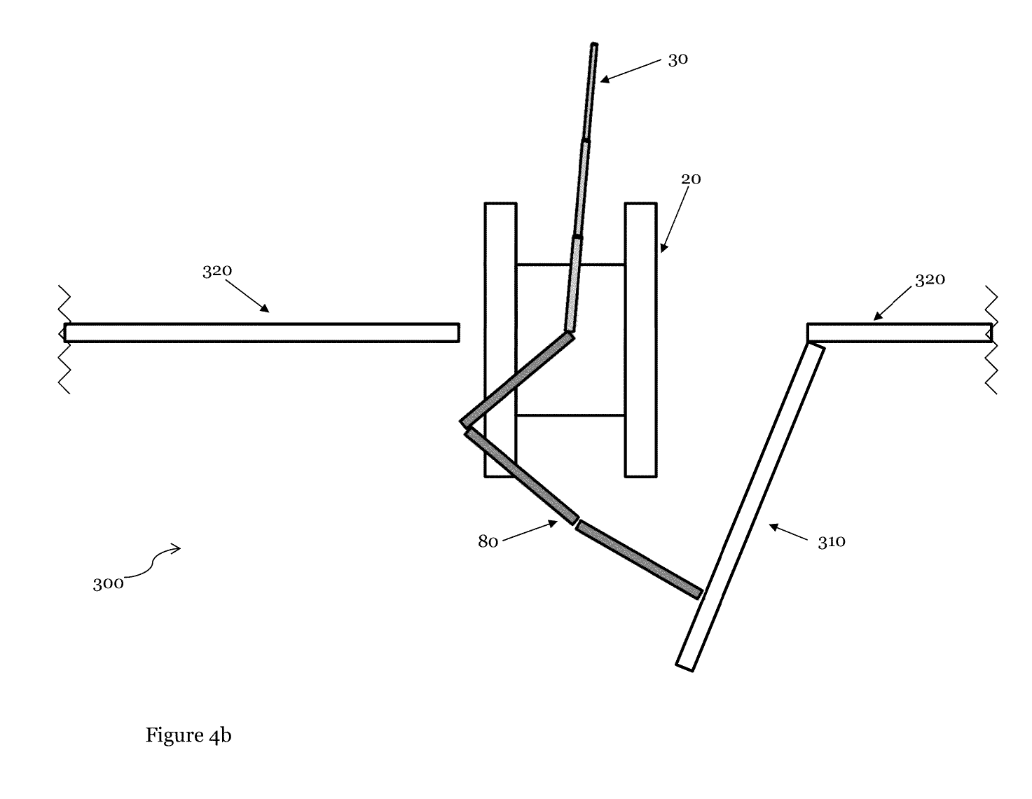

A robot 20 can be equipped with an second utility arm 80, which can be a jointed arm and can be made of hard plastic, steel, carbon fiber, titanium, aluminum, or combinations thereof. As shown in FIGS. 4a and 4b, a robotic system 10 can have the arm 80. The arm 80 can be a single rigid, semi-rigid, or flexible segment. The arm 80 can be comprised of two or more rigid segments connected by hinges, rotary joints, or any other suitable connectors. The segments can be controlled using actuators, hydraulics, or any other suitable method of controlling connectors. The appropriate length of each rigid segment in the jointed arm 80 can be calculated using the dimensions of a robot 20 and the width of the opening, but any suitable dimensions unrelated to the robot size can be used. For example, the arm and/or arm segments can be sized and configured to open a door and hold the door open a sufficient amount, such that the robot may pass through the open door without the arm blocking the robot's path. The hooking arm 80 can be used to manipulate objects in the environment; for example, in a building 300 including a door 310 located inside a wall 320, the arm 80 can be used to hold doors open while humans and/or a robot 20 pass through. In a human-centric environment, the hooking arm 80 can be used to determine the position of a robot 20 relative to walls, doors, and other potential obstacles, push elevator buttons, and/or any other suitable function.

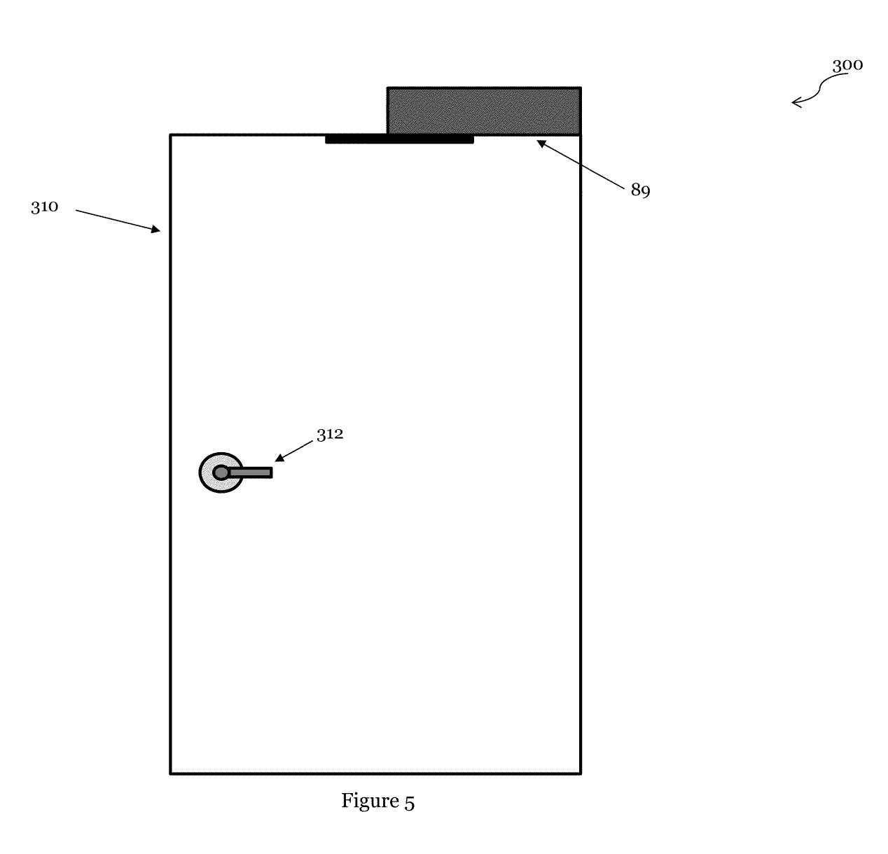

As shown in FIG. 5, a building 300 can be equipped with automatic door openers 89, which can be attached to existing doors 310 and can integrate into existing access control systems. An automatic door opener 89 can be made entirely for robots, such that humans cannot use the automatic door opener but a robot 20 can; alternatively, an automatic door opener can be made for both robot and human use. A robot 20 can use an automatic door opener 89 to open a door 310; for example, a robot 20 can press a push button, swipe a valid access card, use a wireless remote, or communicate with a remote human or robot server to open, close, lock, and unlock doors.

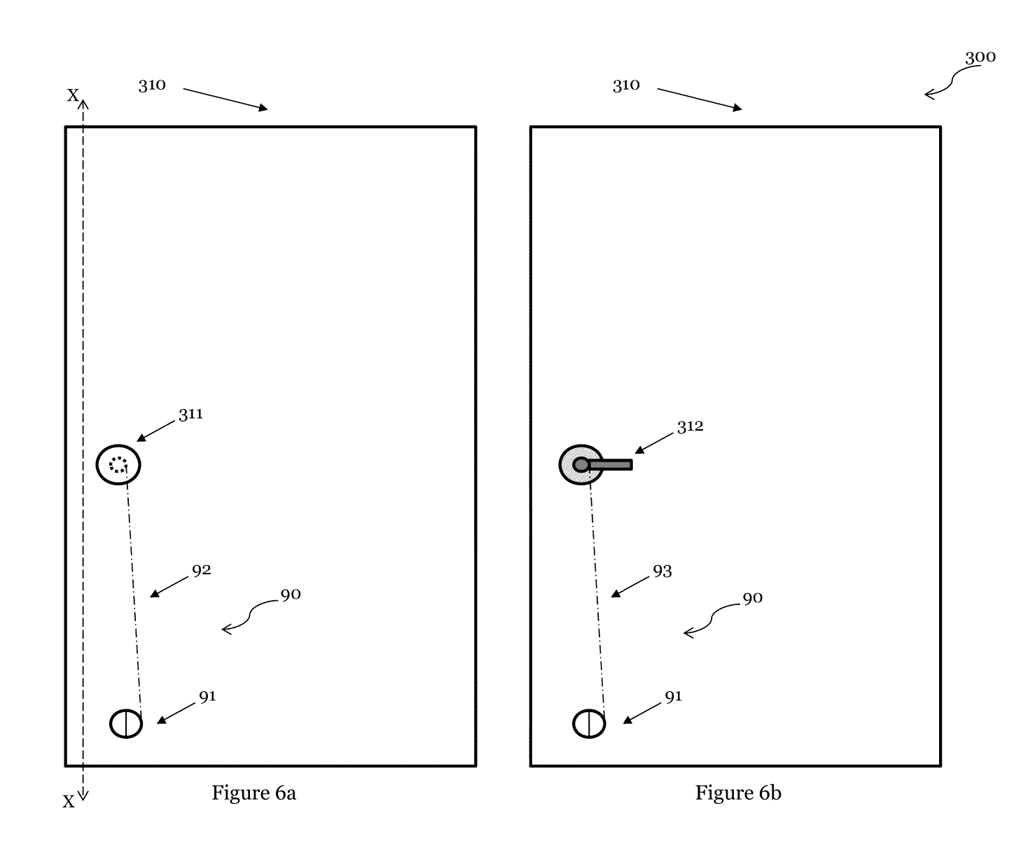

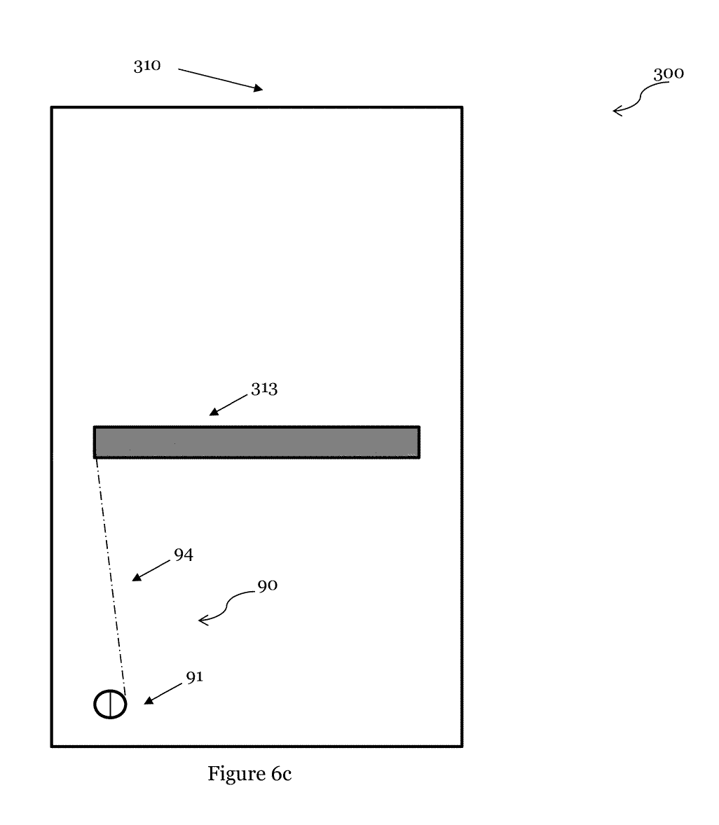

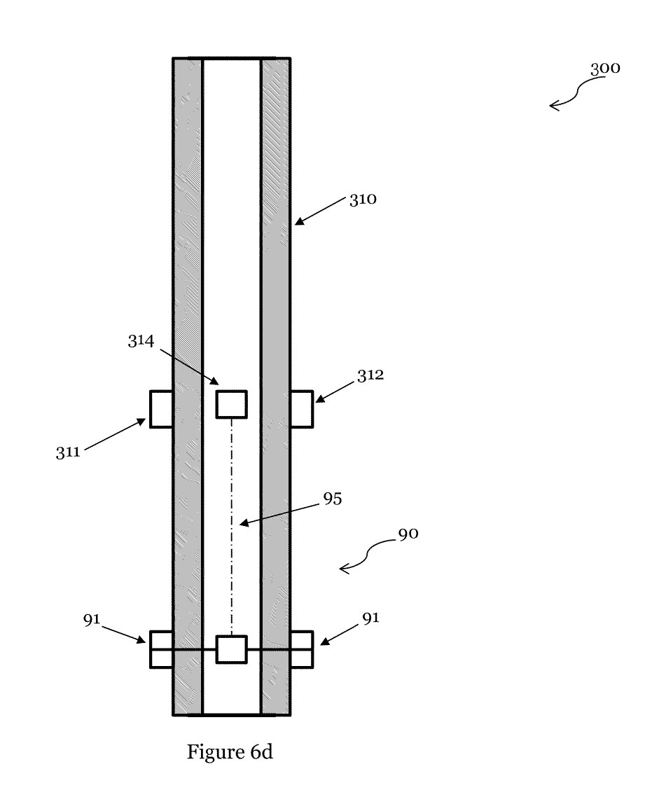

As shown in FIG. 6, a building 300 can be equipped with door adapters 90, which a robot 20 can use to manipulate a door 310 in a human-centric environment. As shown in FIGS. 6a, 6b, 6c, and 6d, the door adapter 90 can include a robot interface 91 and connectors 92, 93, 94, 95, respectively. The connectors may be external to the door, internal to the door, or a combination thereof. The robot interface 91 can be a push button, pin or wafer tumbler lock, combination lock, keypad, access card reader, magnetic lock, magnet, and/or any other suitable fastening device. The connector 92, 93, 94, 95 can be made of metal, chain, springs, and/or any other suitable material, and can function to connect the robot interface 91 to the latching mechanism on the door. As shown in FIGS. 6a, 6b, 6c and 6d, connectors 92, 93, 94, 95, respectively, can be optimized for a variety of latching mechanisms, which can include a door knob 311, a lever-operated handle 312, a crash bar 313, and a sliding latch, respectively. A robot 20 can use a handle adapter 90 to open doors; for example, a robot 20 can insert a matching key into the robot interface 91 and turn the key to pull down on the connector 92, 93, 94, 95, which can apply a torque to the knob and unlatch the door.

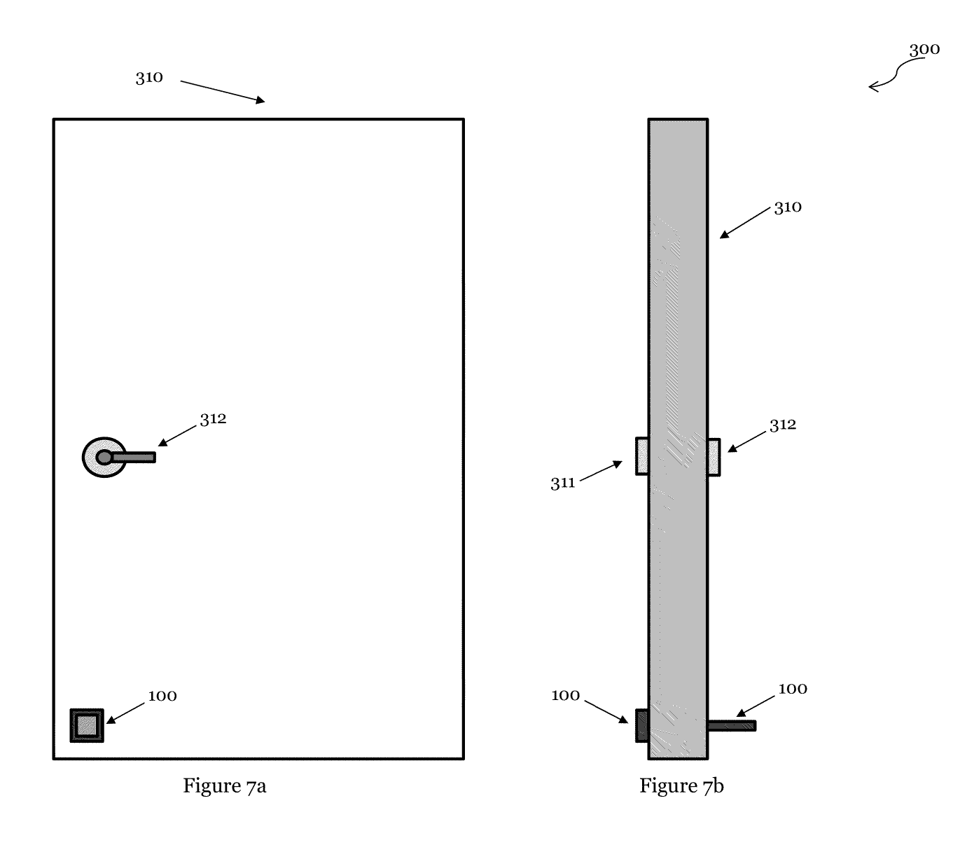

As shown in FIGS. 7a and 7b, a building 300 can be equipped with door pulls 100, which a robot 20 can use to manipulate a door 310 in a human-centric environment. The robot door pull 100 can include a layer of protective material such as rubber, felt, or any other suitable material to prevent a robot 20 from damaging door. As shown in FIGS. 7a and 7b, the door pull 100 can include a magnet, hook, post, spring, or any other device that functions to keep a robot 20 in contact with a door 310. A robot 20 can use a door pull 100 to push or pull doors; for example, a robot 20 can touch a magnet to a door pull 100 and pull the magnet away to open a door. A door pull 100 can be used in combination with a handle adapter 90 and/or a hooking arm 80; for example, a robot 20 can use a handle adapter 90 to unlatch a door, then use a door pull 100 to open the door, and then use a jointed arm 80 to hold the door open while the robot 20 passes through.

A building can be equipped with robot doors that can be embedded in or attached to existing full doors in doorways and/or in walls. The doors can be made from wood, metal, plastic, fabric, or combinations thereof. Robot doors and door frames can be scaled to the size of robots, for example about 10 inches tall by about 20 inches wide, or more narrowly about 8 inches tall by about 16 inches wide, such that typical humans cannot enter through the door but a robot is able to enter. A human full door can be divided into one or more hinged partitions, for example, such that a robot can enter through a hinged lower partition of the full door, but the lower partition would be too small for a human to enter or at least significantly hinder the human trying to enter through the lower, robot partition. A garage-type door (e.g. a segmented door on a curved and/or straight track) driven by a motor or other actuator can have multiple settings to allow different types of entry. For example, a garage-type door can rise entirely for a human or automobile to enter and can also rise only 8 inches to allow a robot to enter. A robot can have access to control some or all of the open settings of such a garage door; for example, a robot can be cleared only to allow robot entry or can be cleared to allow both robot and human entry. A robot door can be opened and closed using actuators, hydraulics, magnets, or any other suitable method of opening and closing the door. In a human-centric environment, a robot can use a robot door to pass through doors and walls.

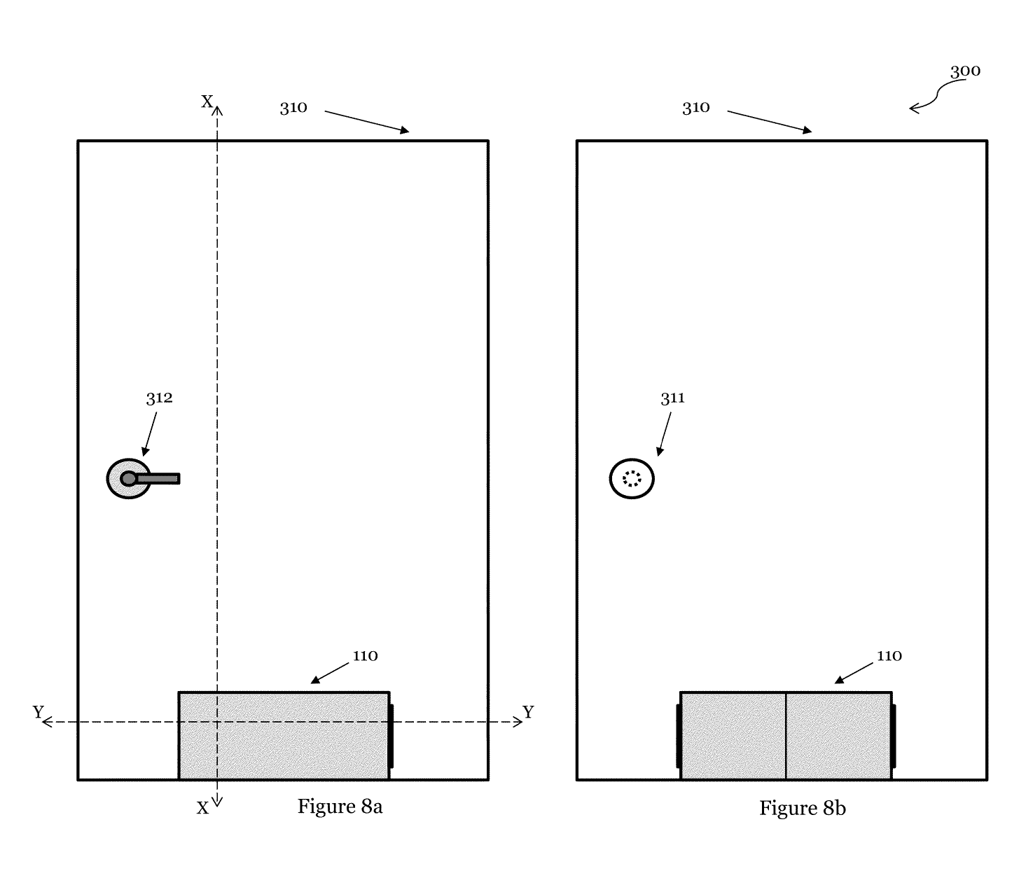

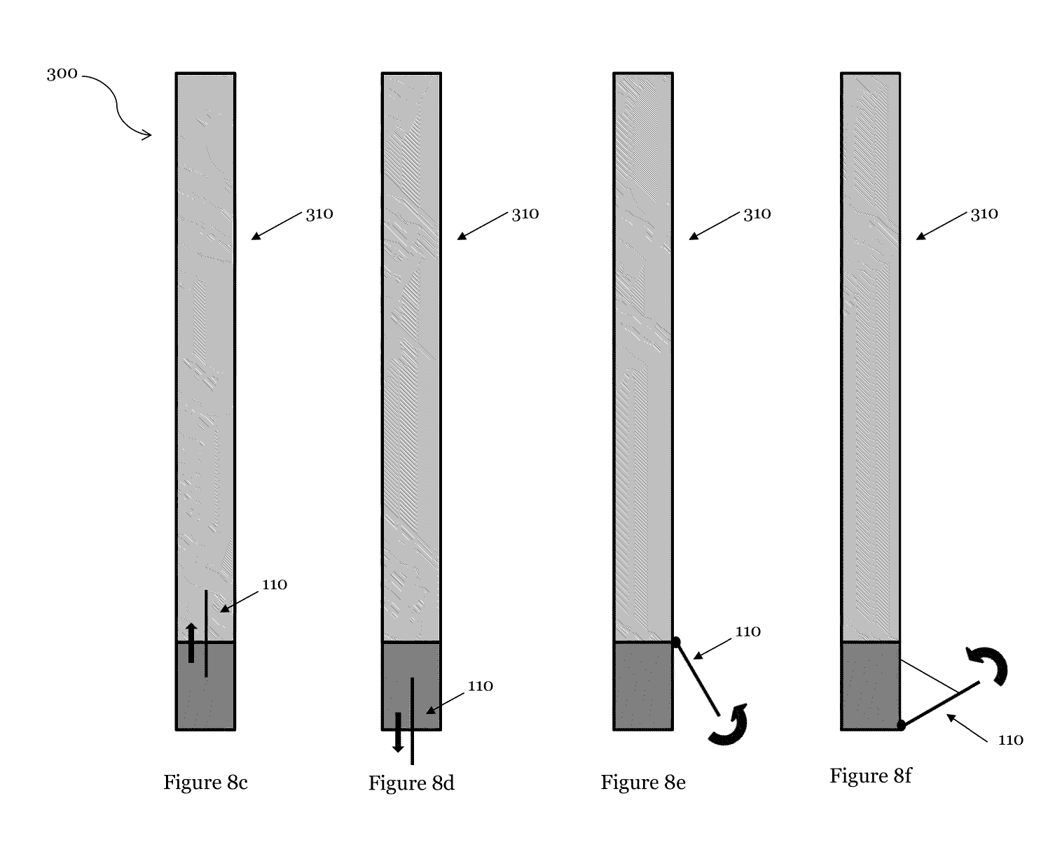

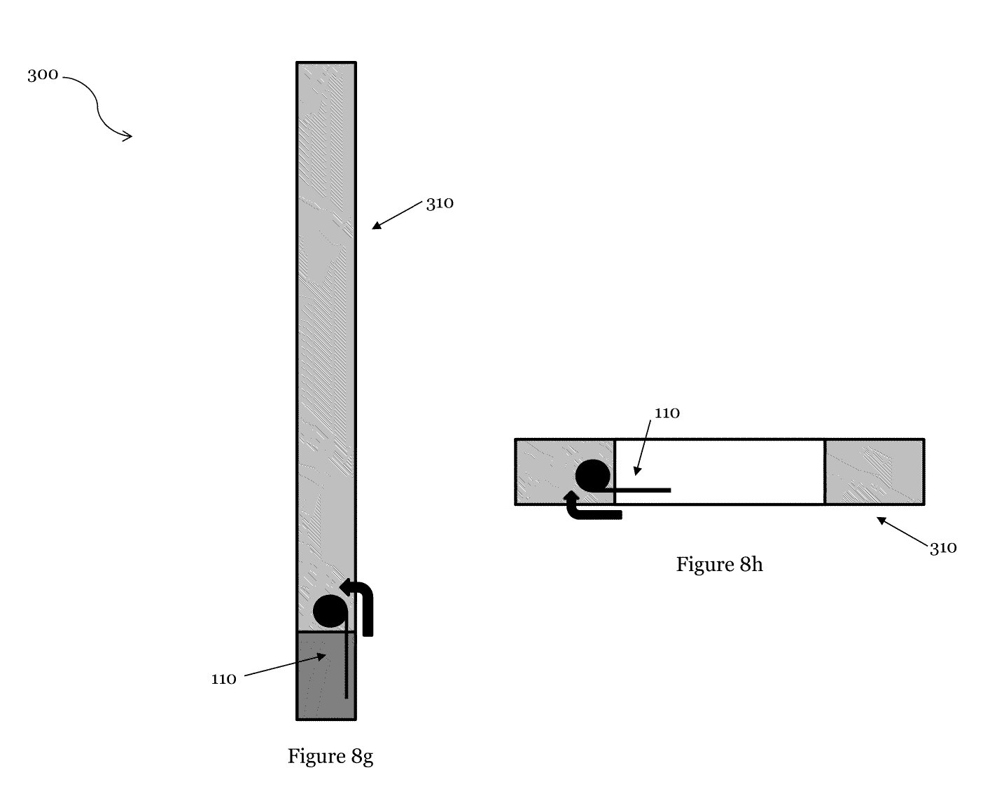

As shown in FIGS. 8a and 8b, a robot door 110 can be embedded in a full door 310 and can hinge from one side or can be split in the lateral middle (e.g., with the split extending vertically) with hinges on both lateral sides of the door. The robot door 110 can have one or more panels at the terminal bottom of the full door 310. The robot door 110 can be a lower partition of the full door 310, and the remainder of the full door can be an upper partition of the full door 310. The robot door 110 can be rigid or flexible. When the robot door 110 is opened, the robot can move through the opening, partially or completely traversing the plane of the full door 310.

As shown in FIGS. 8c and 8d, the robot door 110 can be embedded in a door 310 and can slide up into the door or down into the floor. As shown in FIGS. 8e and 8f, a robot door 110 can be embedded in a door 310 and can hinge from the door to open by swinging up or hinge from the floor to open by swinging down. As shown in FIGS. 8g and 8h, a robot door 110 can be embedded in a door 310 and can roll up or to the side. A robot 20 can use a robot door 110 to pass through doors without manipulating the latch on the existing door 310; for example, a robot 20 can press a push button to open a robot door 110.

The robot door 110 can be opened by an actuator receiving an “open” signal from a sensor sensing an encoded wired (e.g., by insertion of an access card into a card reader slot by the door)) or wireless signal, such as RF, Bluetooth, Wi-fi signals, or combinations thereof, emitted by the robot or an access card or chip on or held by the robot, or sent from a server caused by a communication from the robot (e.g., the robot sending the server the robot's coordinates causing the server to open the door). The actuator can unlock and/or open the robot door 110. The actuator can lock and/or close the robot door 110 after the robot traverses the doorway and is clear of the robot door 110 (e.g., detected by an IR sensor) or when the robot sends a signal to close the robot door 110. The upper partition can remain closed when the robot door opens 110.

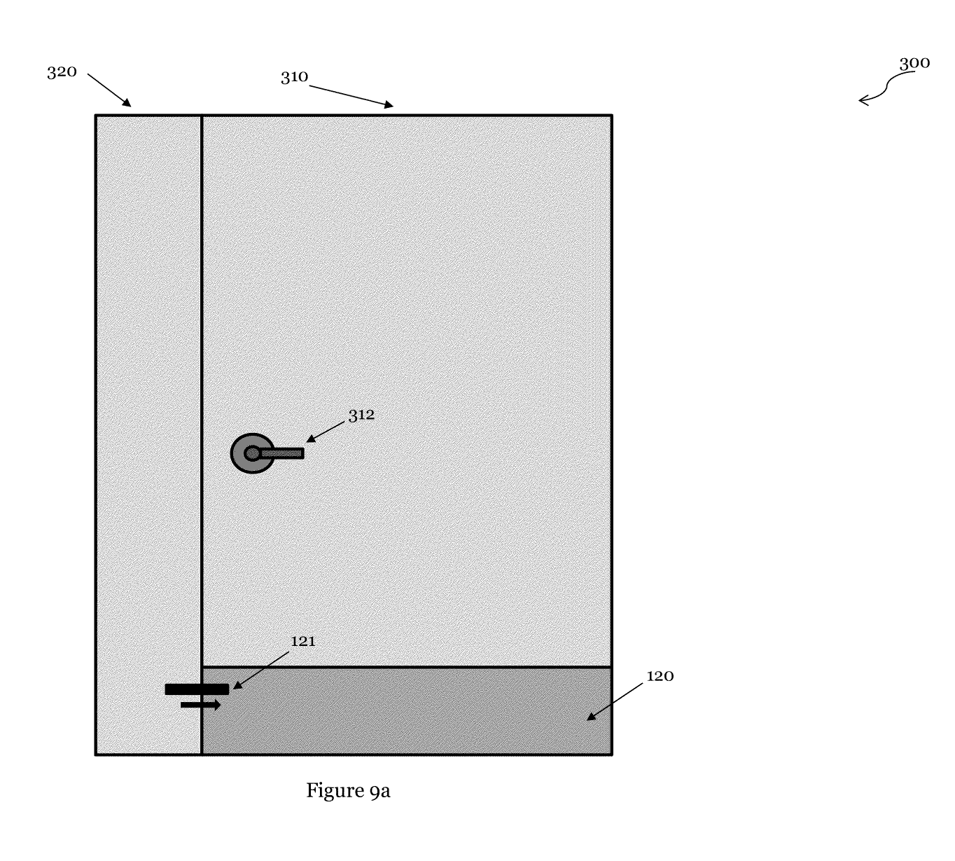

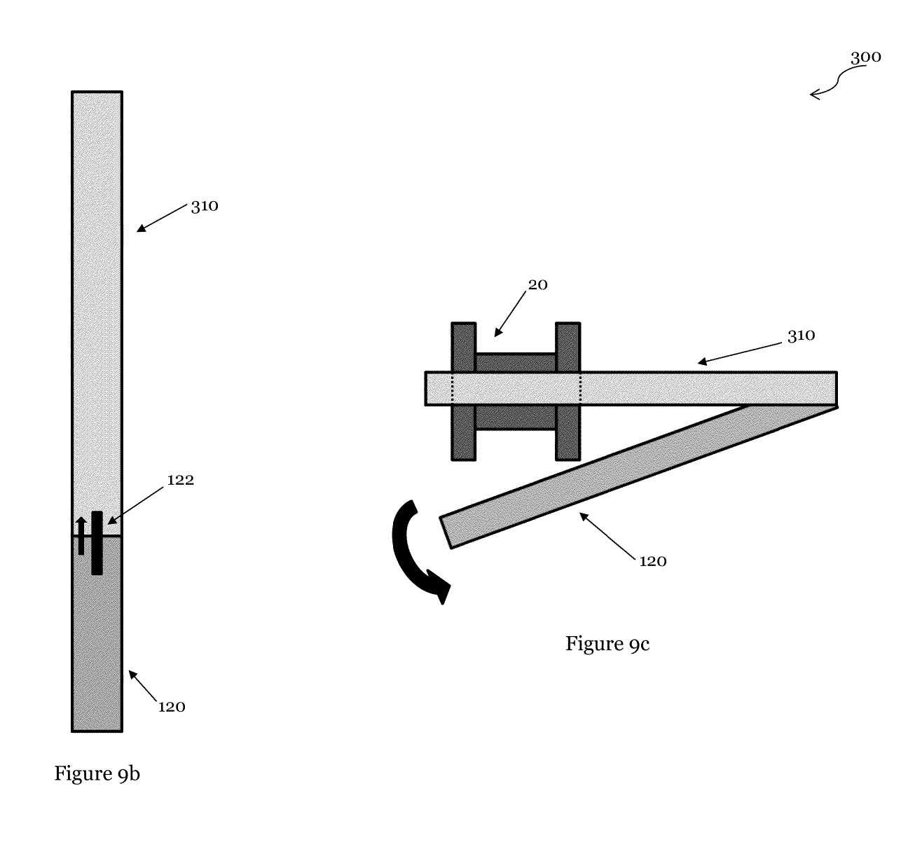

As shown in FIGS. 9a and 9b, half doors and/or partial doors 120 can be built into existing doors 310 or installed into existing doorframes. The height of a half door 120 can be optimized for a robot 20, and a sub-door 120 can include an external latching mechanism 121 or an internal latching mechanism 122. A latching mechanism 121 or 122 can be a sliding lock, deadbolt, access card reader, and/or any other suitable latching mechanism. A partial door 120 can be equipped with a robot door handle or pull 100.

As shown in FIG. 9c, a robot 20 can use a partial door 120 to pass through doors without manipulating the latch on the existing door 310; for example, a robot 20 can push a sliding latch 121 in the appropriate direction to unlatch the partial door 120.

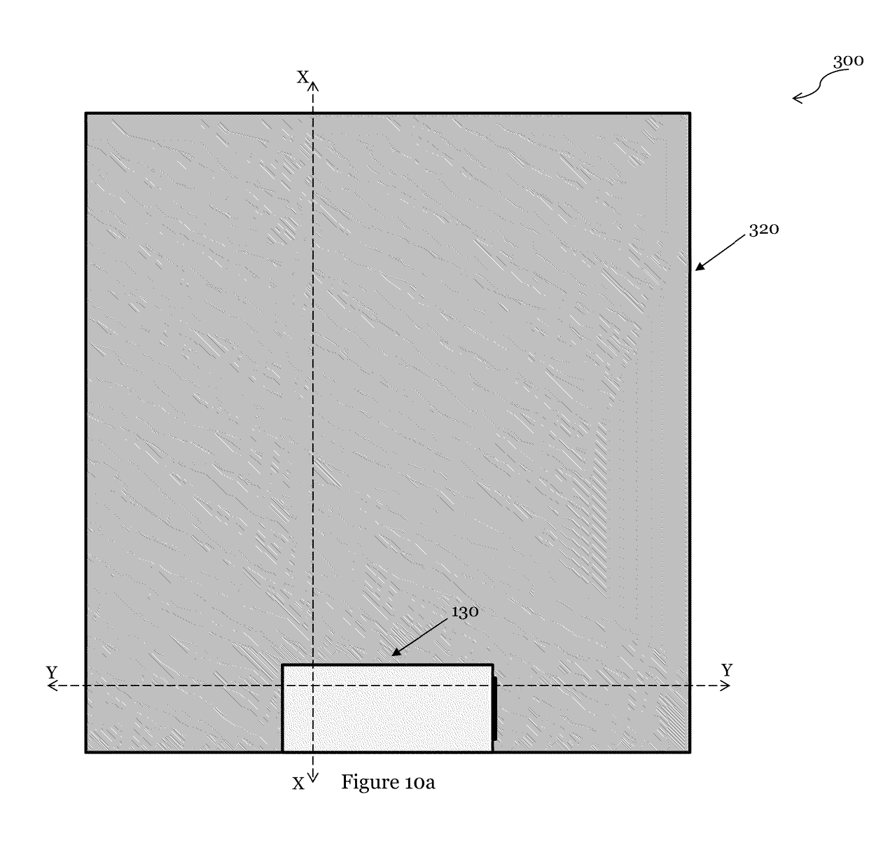

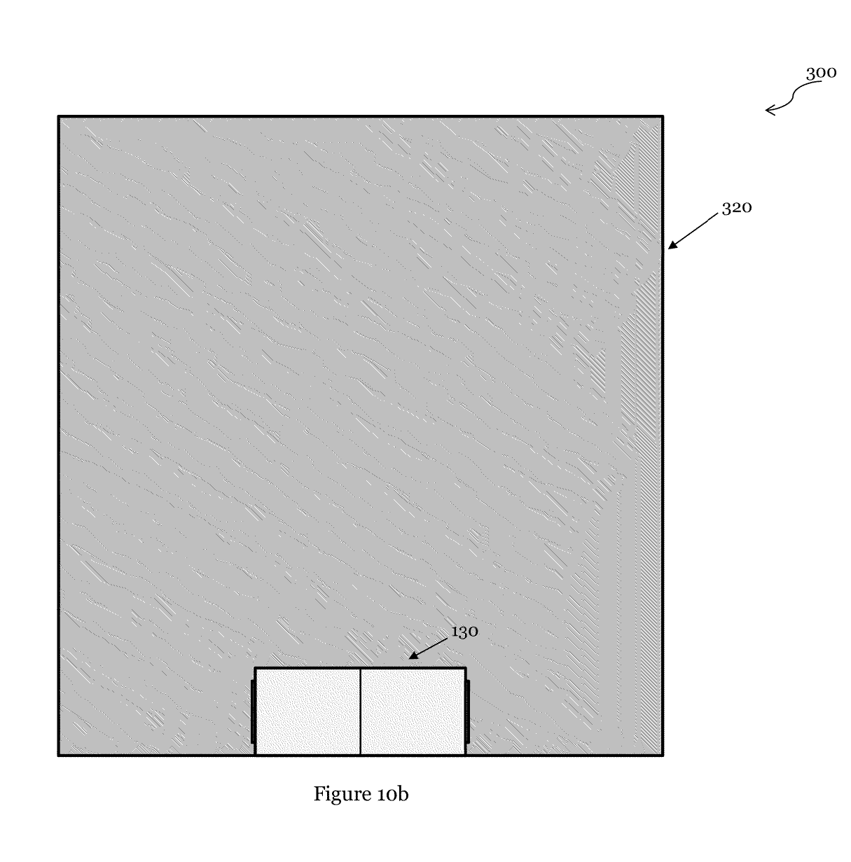

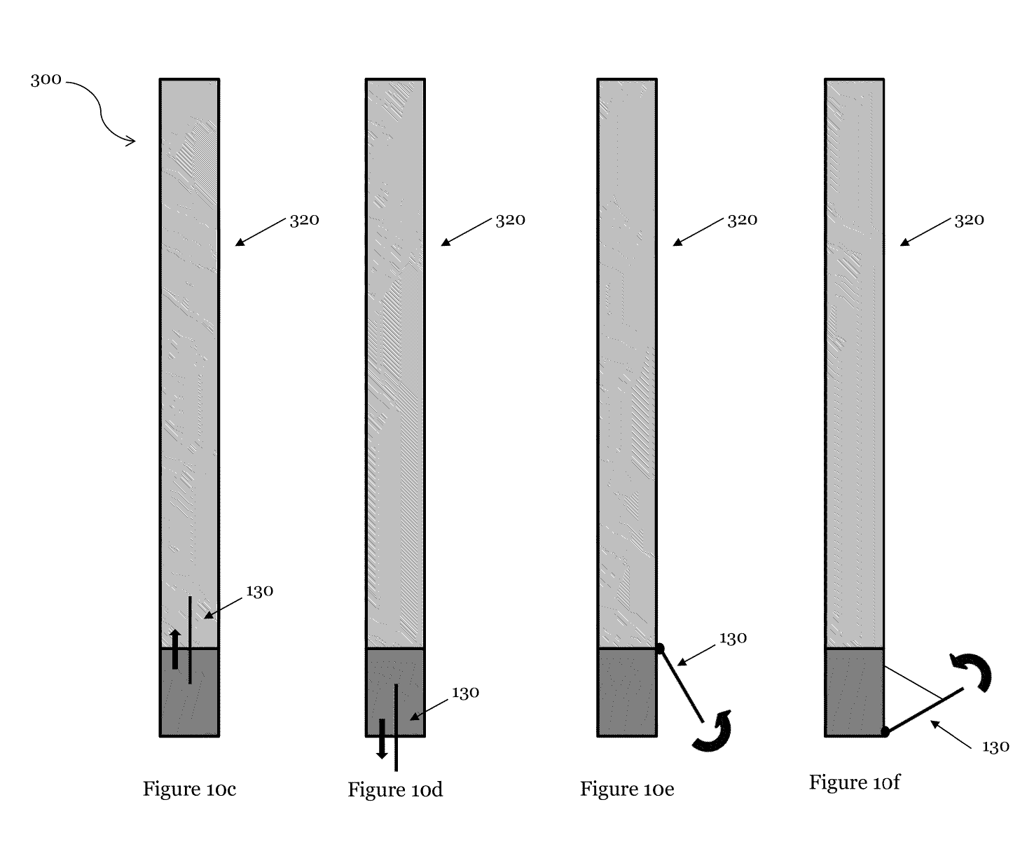

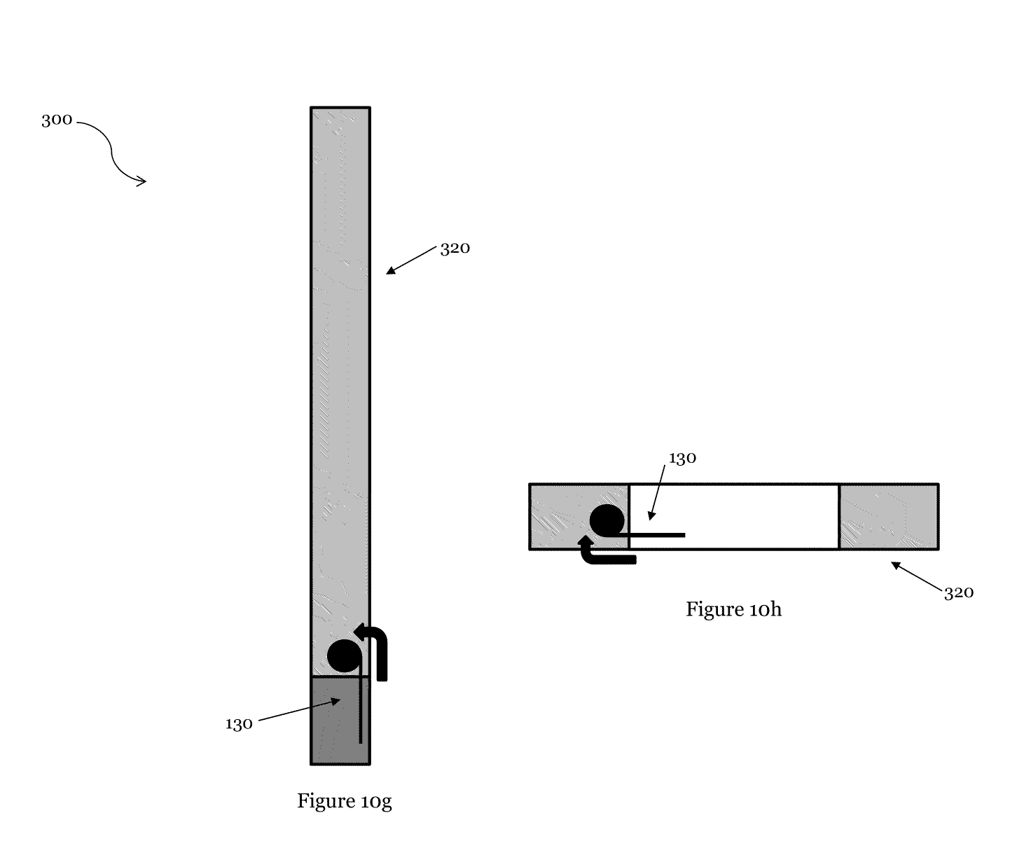

As shown in FIGS. 10a and 10b, separate robot doors 130 can be built into existing walls 320 and can hinge from one side or can be split in the middle with hinges on both sides. As shown in FIGS. 10c and 10d, a separate robot door 130 can be embedded in a wall 320 and can slide up into the wall or down into the floor. As shown in FIGS. 10e and 10f, a separate robot door 130 can be embedded in a wall 320 and can hinge from the wall to open by swinging up or hinge from the floor to open by swinging down. As shown in FIGS. 10g and 10h, a separate robot door 130 can be embedded in a wall 320 and can roll up or to the side. A robot 20 can use a separate robot door 130 to pass through walls without manipulating existing doors; for example, a robot 20 can insert a matching key into a separate robot door 130 and turn the key to unlatch the robot door 130.

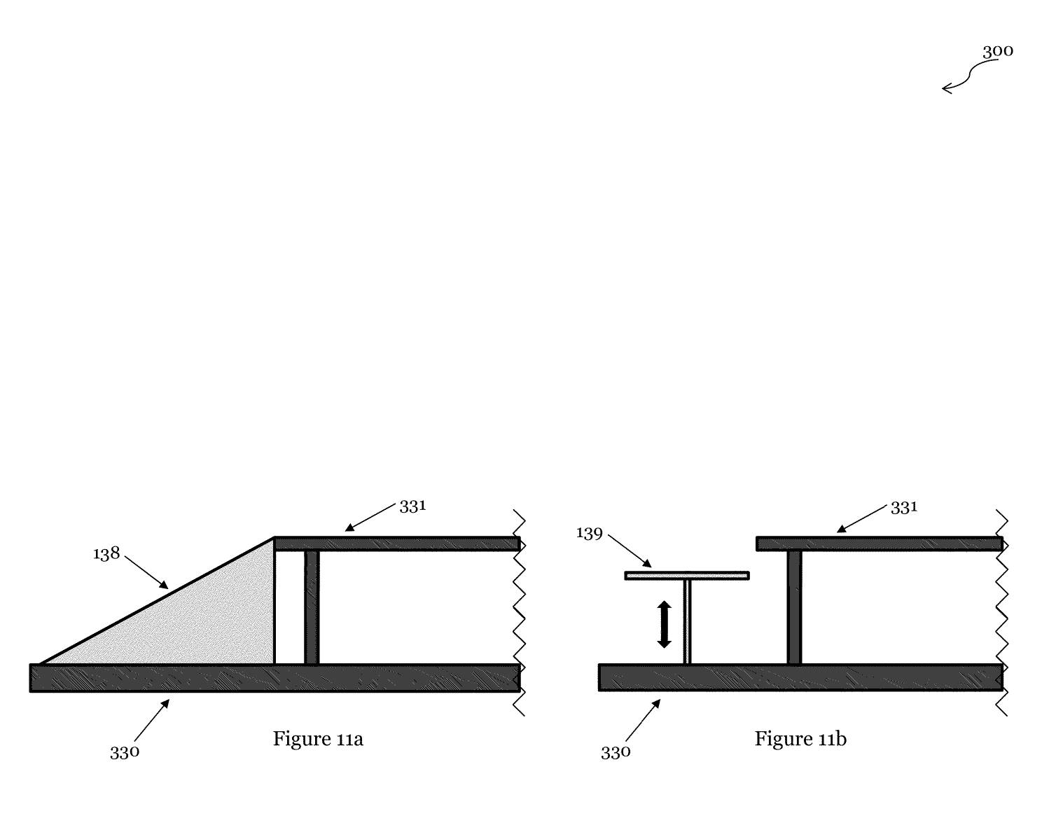

A building can be equipped with one or more robot ramps and/or robot elevators to allow robots to work at a variety of heights in a human-centric environment. As shown in FIG. 11a, a robot ramp 138 can include an inclined plane and can be optimized for use with a piece of furniture or any other suitable object; for example, a robot 20 can drive up a robot ramp 138, park on a table 331, and perform tasks alongside human workers. As shown in FIG. 11b, a robot elevator 139 can include an appropriately-sized platform that can be raised and lowered using actuators, hydraulics, or any other suitable method of raising and lowering a platform. A robot can use a robot elevator 139 to change its elevation; for example, a robot 20 can drive onto the elevator 139, raise the platform to a height above a table 331, and make a visual recording of a business meeting.

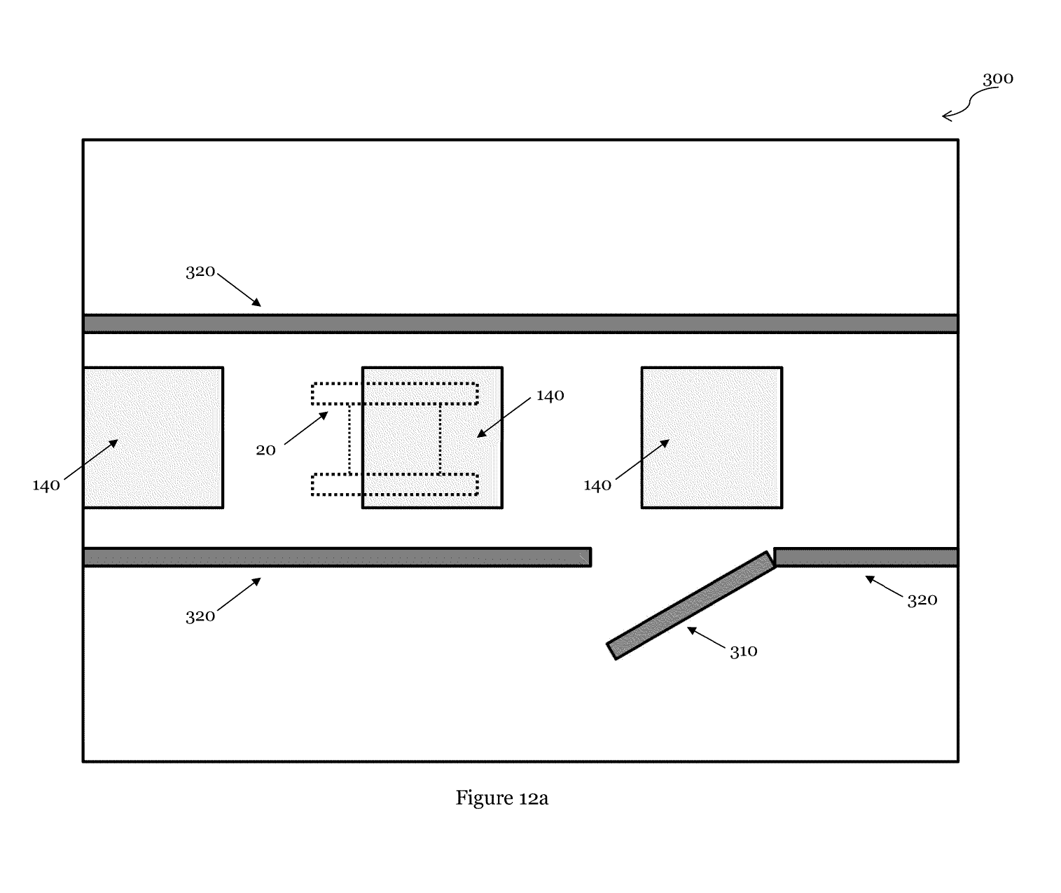

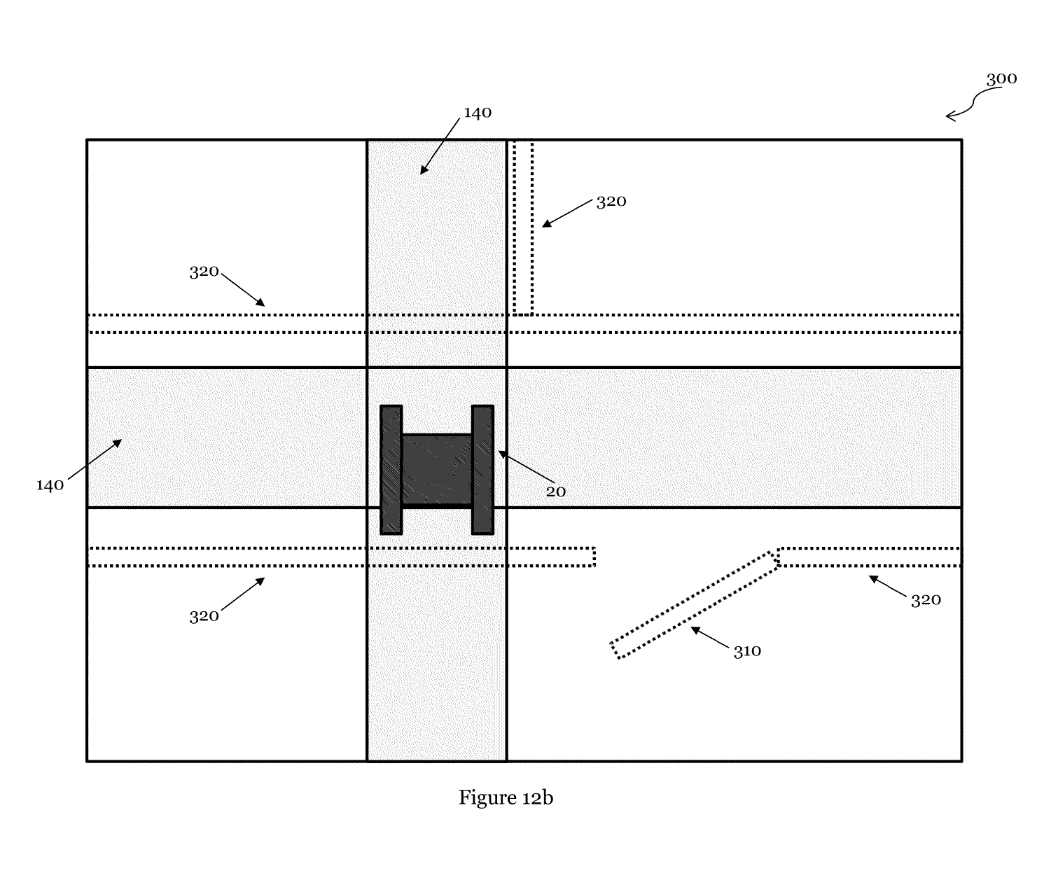

A building can be equipped with panels of glass, such as plexiglass, safety glass, window glass, one-way glass, mirrored glass, tinted glass, and/or any other suitable transparent material that can be installed in walls, ceilings, and/or floors and can allow a robot to traverse the building unhindered by obstacles presented by a human-centric environment. Glass tiles can be installed such that a robot can have access to the entire building or only certain areas. Glass tiles can enable a robot to record visually what is happening in an area while being possibly out of sight and can create the possibility that events happening an area will be recorded, which can affect employee and/or citizen behavior. Glass tiles can also allow robot operators to quickly observe a room (via the robot cameras) without needing to enter it. As shown in FIG. 12a, panels of one-way glass 140 can be embedded in floors and a robot 20 can drive in the space below the floor to perform security checks, maintenance tasks, and other activities without being seen. As shown in FIG. 12b, panels of safety glass 140 can be embedded in ceilings and a robot 20 can drive in the space above the ceiling.

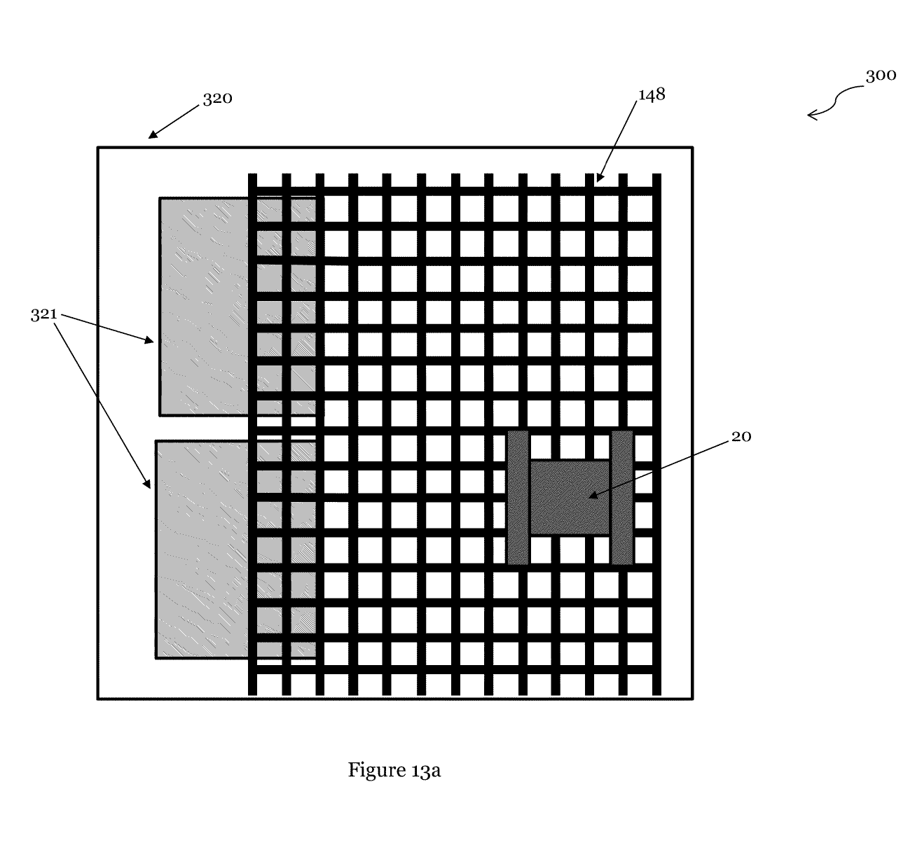

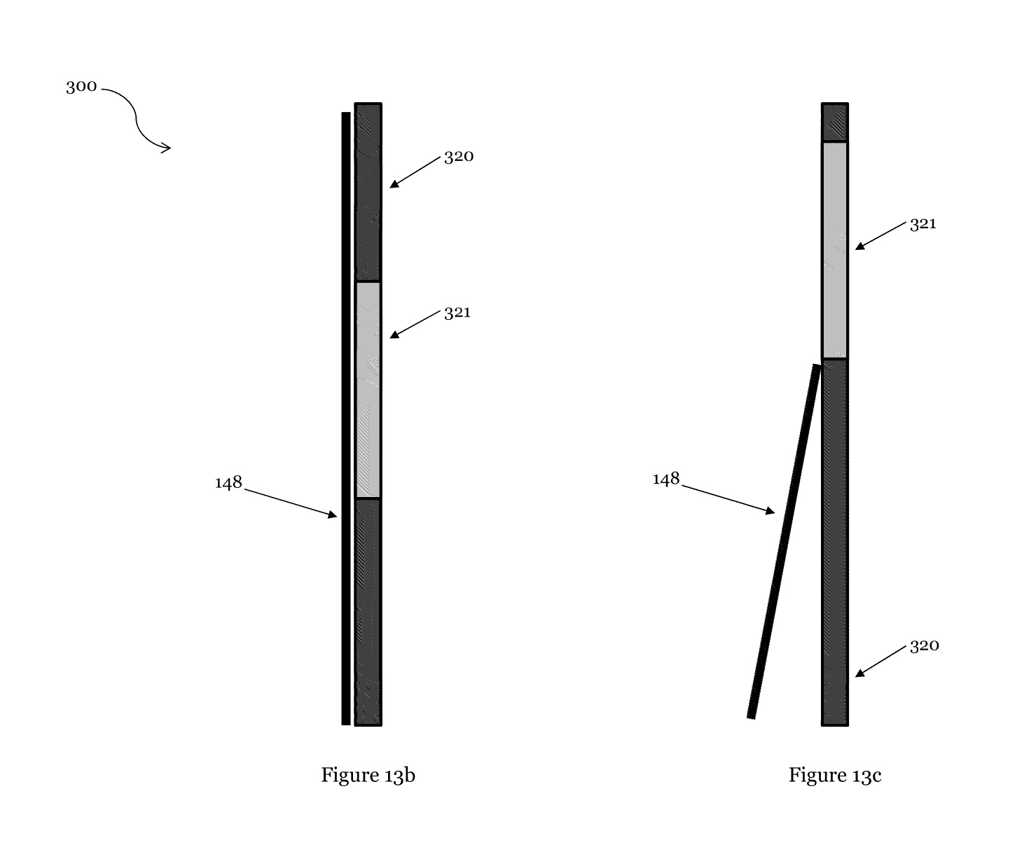

A building can be equipped with cargo nets, fences, scaffolding, ladders, trestles, and/or any other suitable material that can be attached to existing walls and can allow a robot to climb the building. Cargo nets can cover the entire exterior of a building or can partially cover a building, focusing on specific areas, and can provide optimum visibility for humans inside a building, allowing them to see through windows. As shown in FIG. 13a, cargo nets 148 can be designed to support a robot's weight but not a human's weight such that a robot can climb a cargo net 148 but even a small human cannot. As shown in FIGS. 13b and 13c, a building can be equipped with cargo nets 148 that are nearly vertical or cargo nets 148 that are angled with respect to to the building. A robot can use a cargo net 148 to climb a building, access the roof, perform security checks, and/or perform any other suitable task.

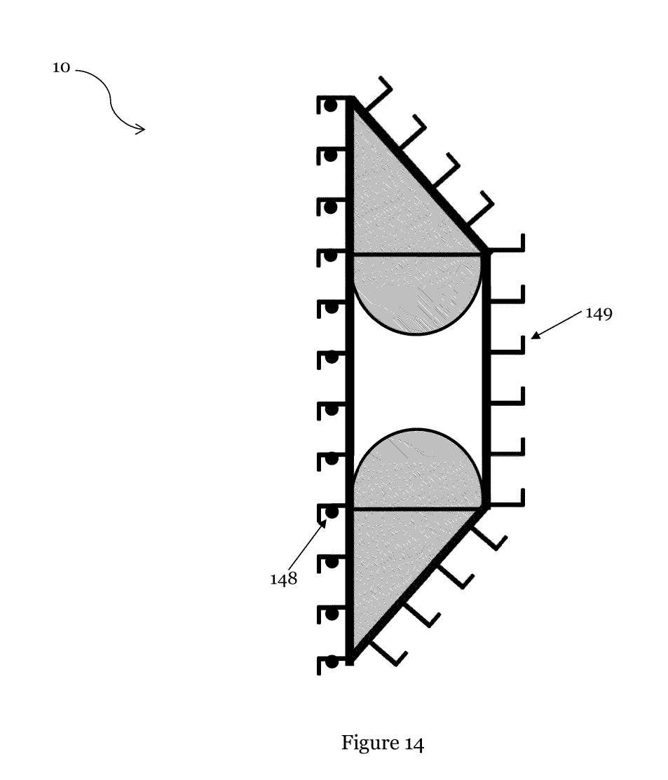

A robot can be equipped with tracks, which can include climb assist functionality to assist a robotic system in climbing various objects. Climb assisting functionality can include hooking protrusions extending from a robotic system track that can grab and pull on an object and also allow a robot to drive regularly on a surface without damaging it. As shown in FIG. 14, hooking protrusions 149 can be optimized to grab the threads of a cargo net or wires of a chain-link fence 148. A robot 20 can use tracks with hooking protrusions 149 to climb cargo nets 148, ladders, rope ladders, scaffolding, fences, trestles, and/or any other suitable materials.

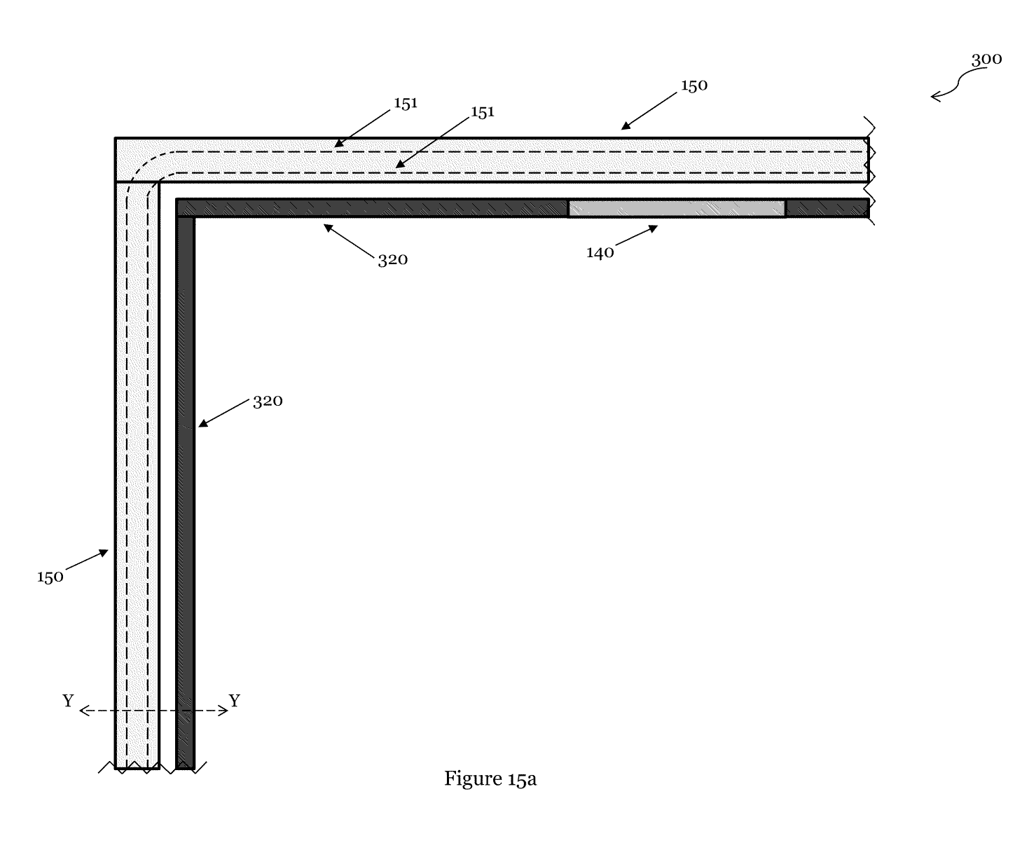

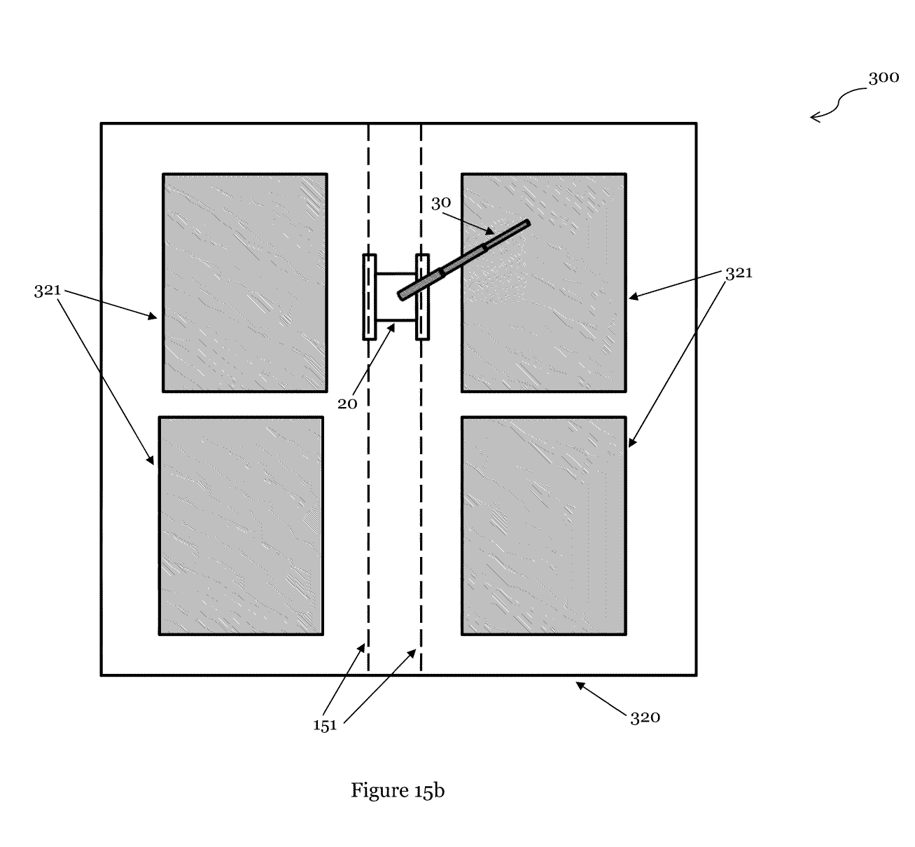

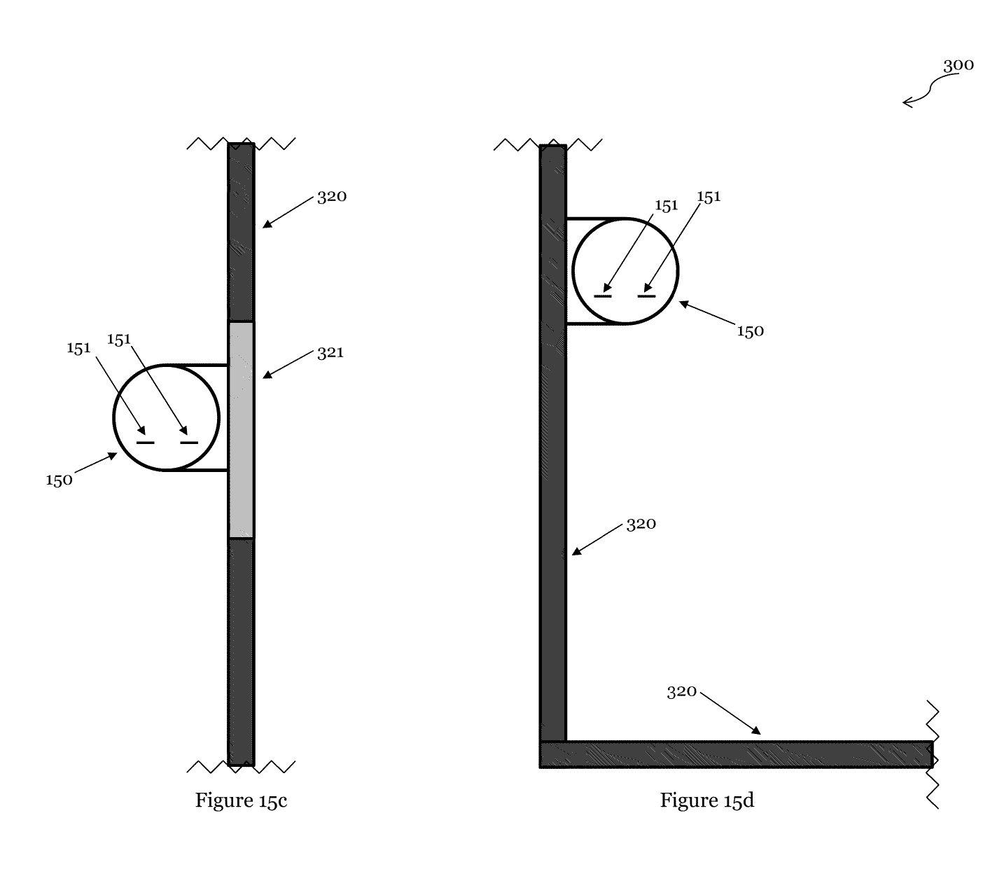

As shown in FIGS. 15a to 15d, a building can be equipped with one or more robot track systems 150, which can be attached to existing walls, floors, ceilings, and/or any other suitable objects or locations and can be made for internal or external use on a building. A track system 150 can include one or more parallel tracks 151 along which a robot 20 can travel and perform tasks. A track system can be encased in a clear tube, as shown in cross section in FIGS. 15c and 15d. In some embodiments, the tubes may be made of glass, plexiglass, hard plastic, or any other suitable material. As shown in FIGS. 15a, 15b, and 15c, a robot 20 can use an external track system 150 to investigate reports of suspicious activity outside building entrances, collect current weather data, wash windows, record when personnel enter and leave the building, access the roof, and/or any other suitable task. As shown in FIG. 15d, a robot 20 can use an internal track system 150 to monitor building cleanliness, wash windows, record conferences, convey inter-building messages and deliveries, guide visitors to their destinations, and/or any other suitable task. As shown in FIG. 15d, the track may be elevated above the ground. In some embodiments, the tracks (and tubes) may run through walls and up and down levels, thus obviating the need for special robot doors, ramps, elevators, or other access devices and systems. Alternatively, a building can be equipped with one or more vertical and/or horizontal ladders and a robot can use hooked tracks 149 to climb along the ladders.

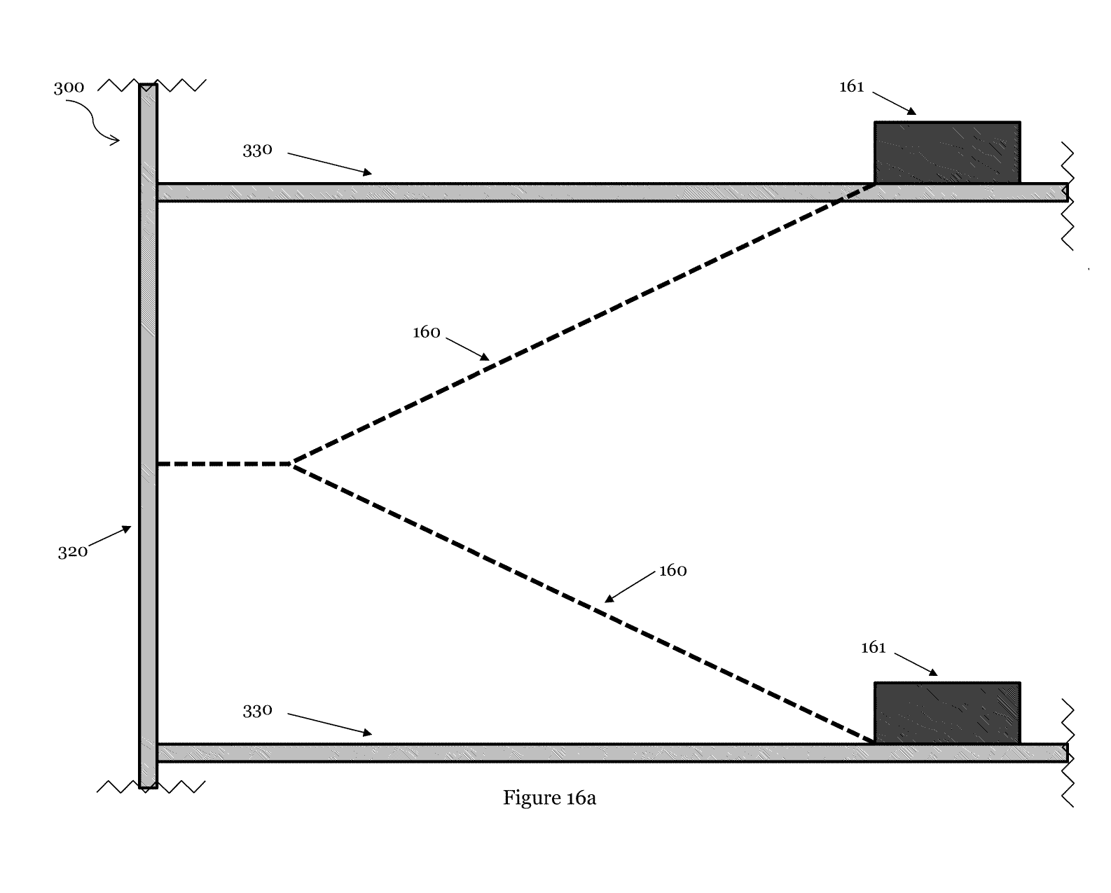

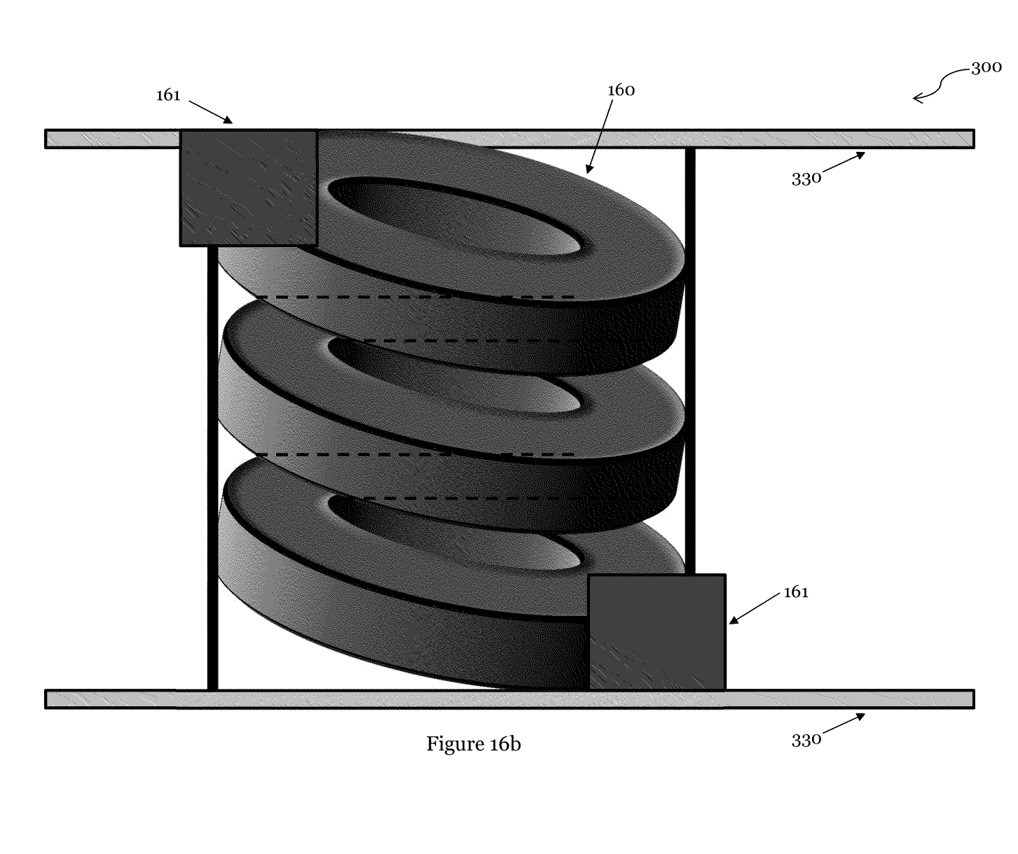

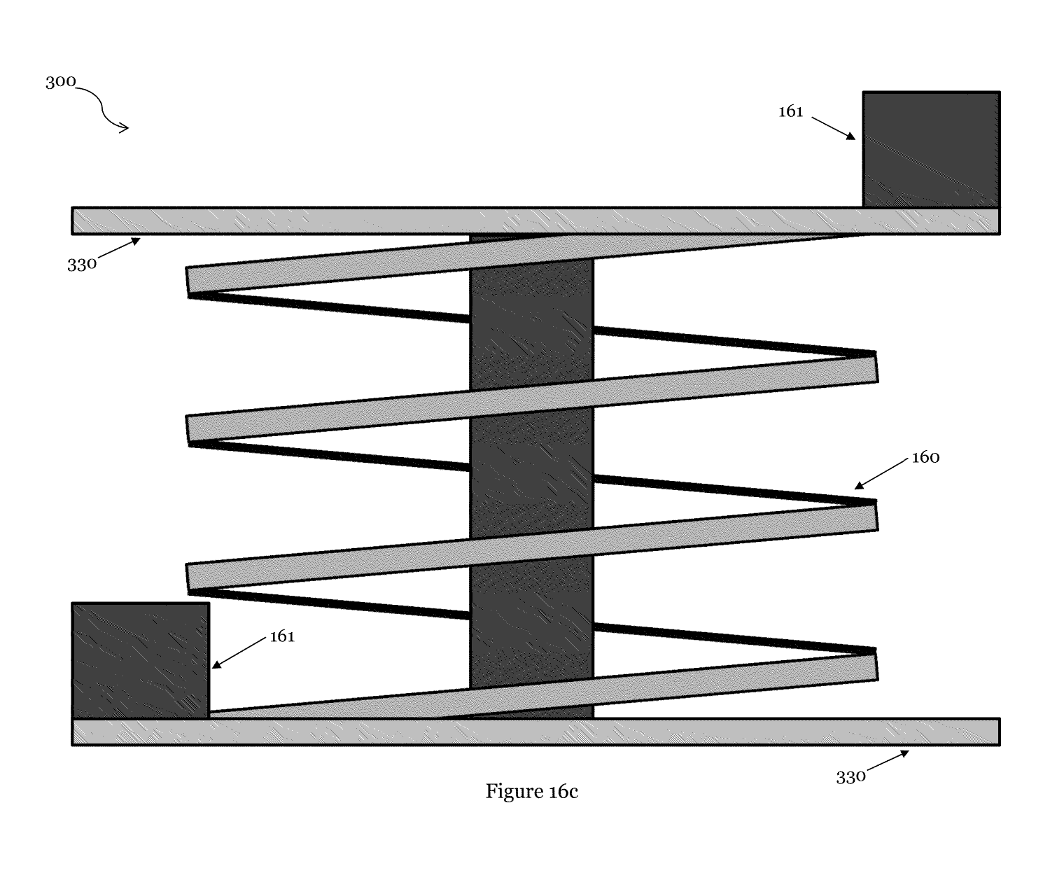

As shown in FIGS. 16a-16c, a building can be equipped with one or more robot ramps 160, which a robot 20 can use to traverse between floors. As shown in FIG. 16a, a robot ramp 160 can be built into an existing wall 320 such that humans cannot access the ramp 160 but robots can. A robot ramp 160 can include openings 161, which can be robot doors 130 and can include any suitable latching mechanism. As shown in FIGS. 16b and 16c, a ramp 160 can be circular and can be optimally sized for a robot 20 to prevent or at least hinder use by humans.

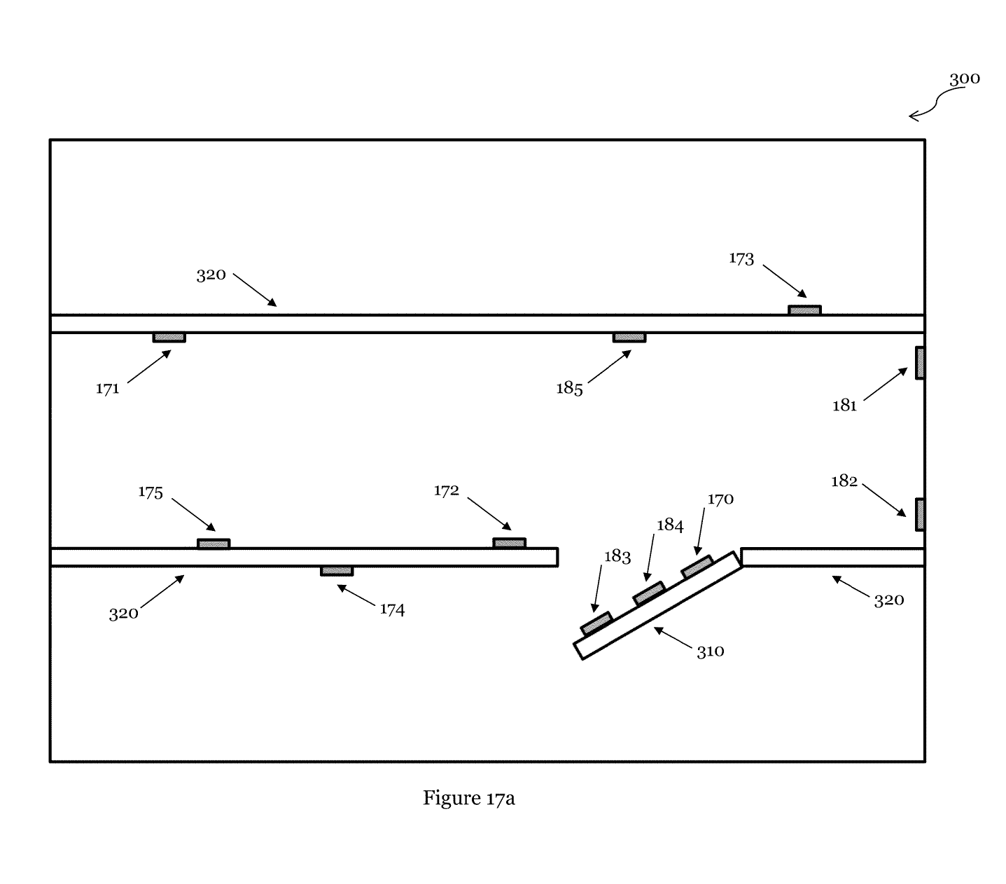

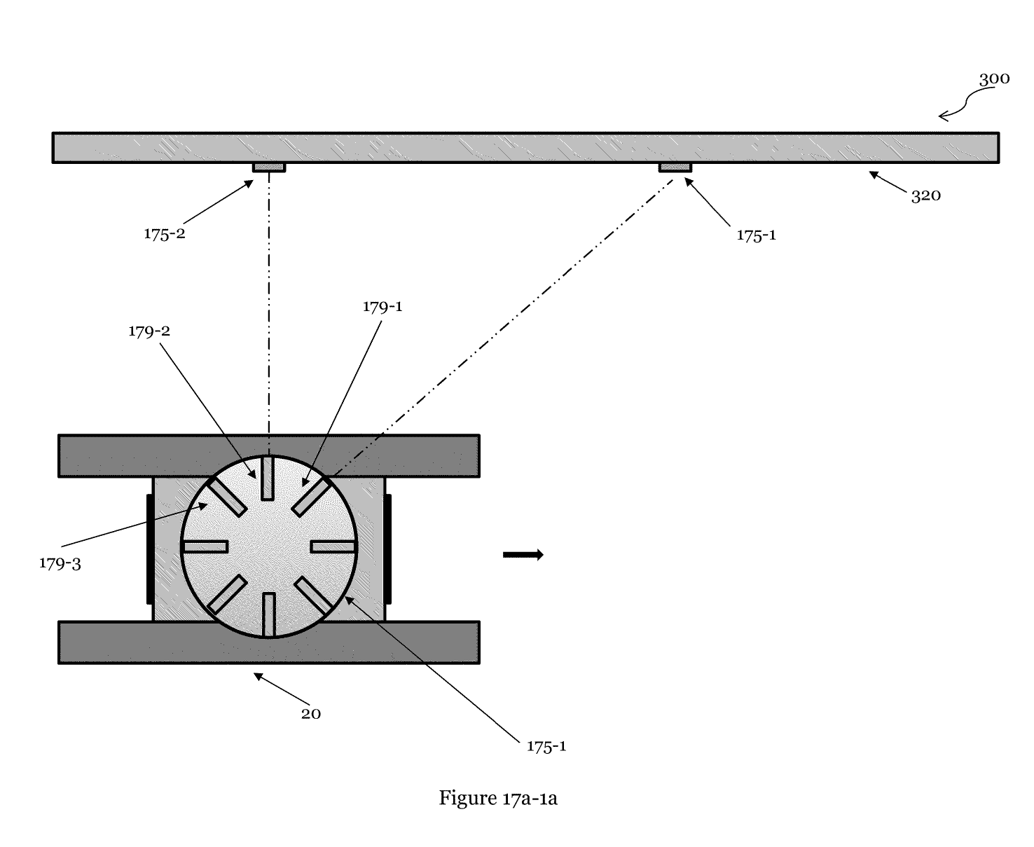

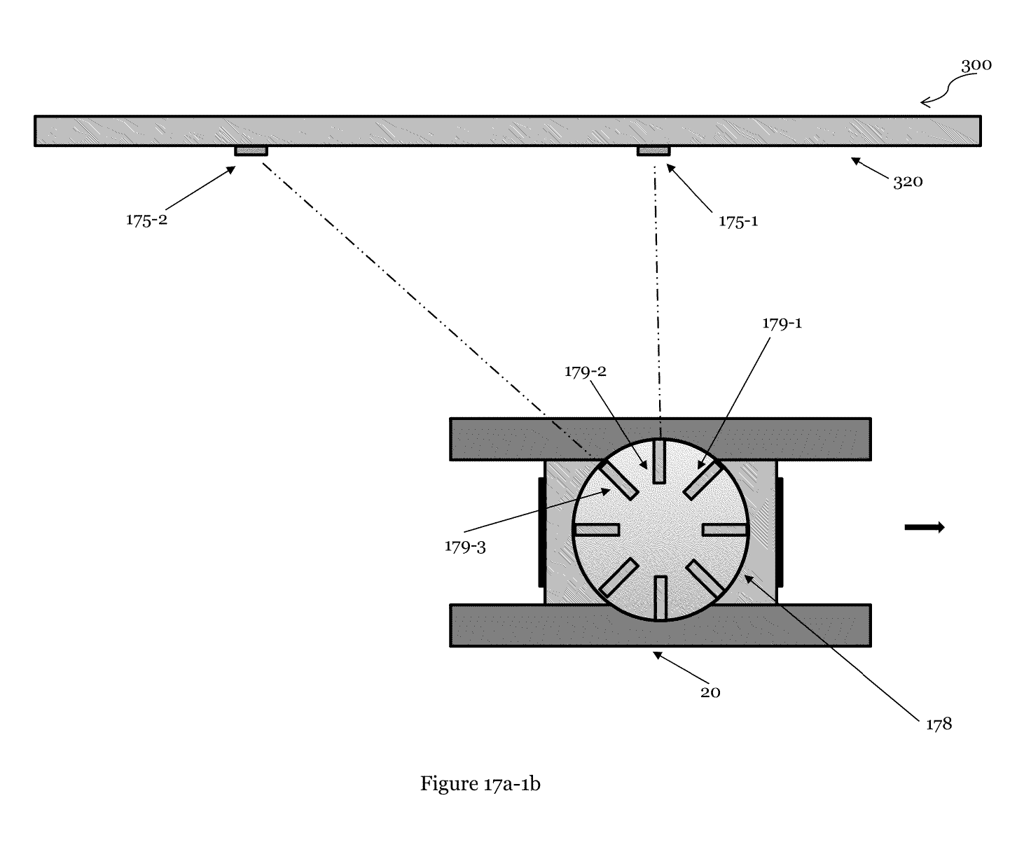

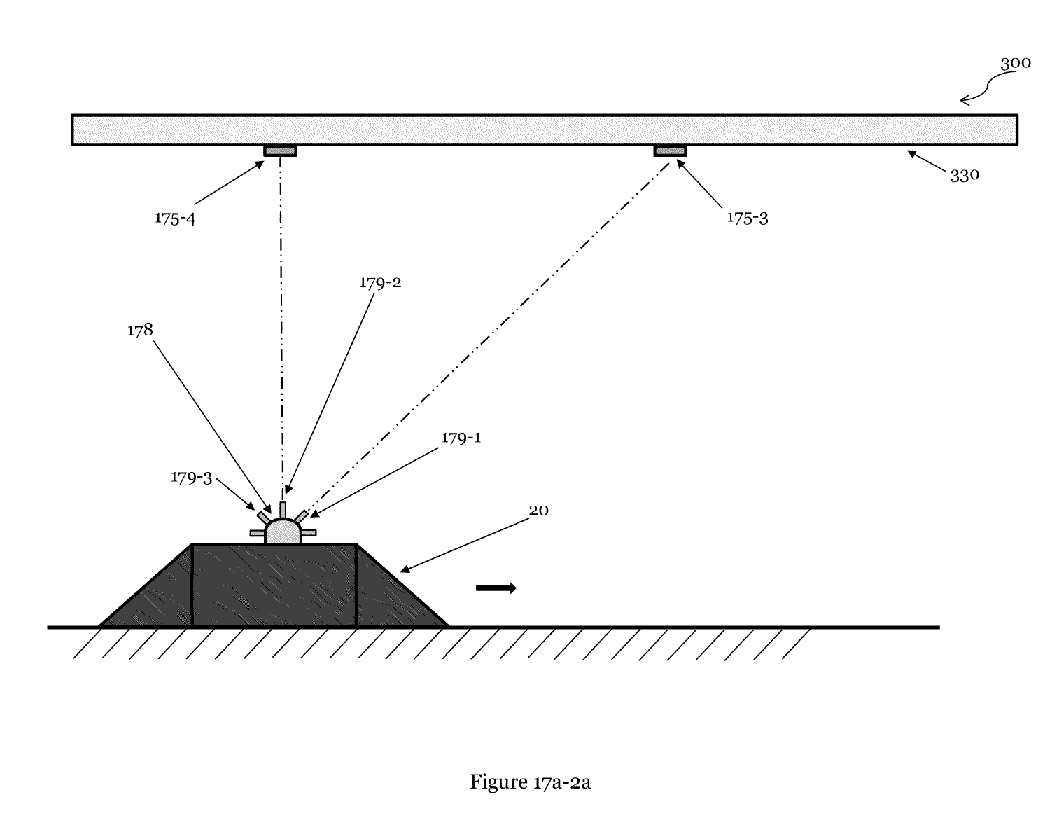

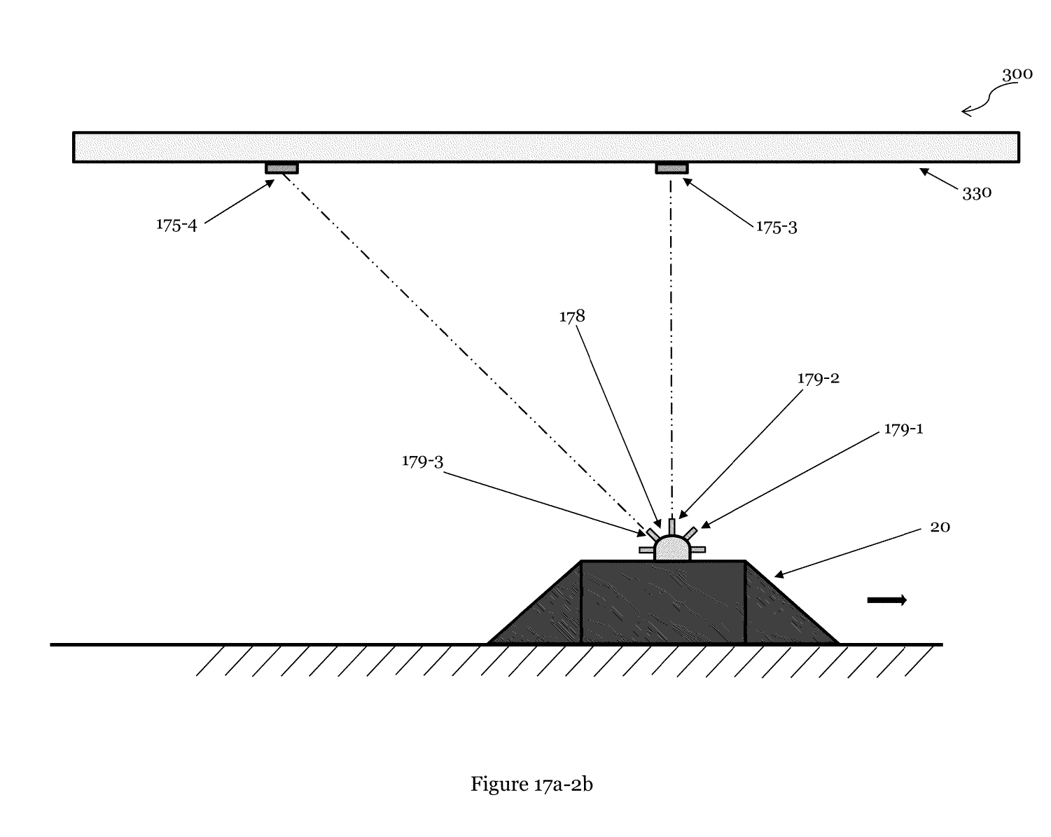

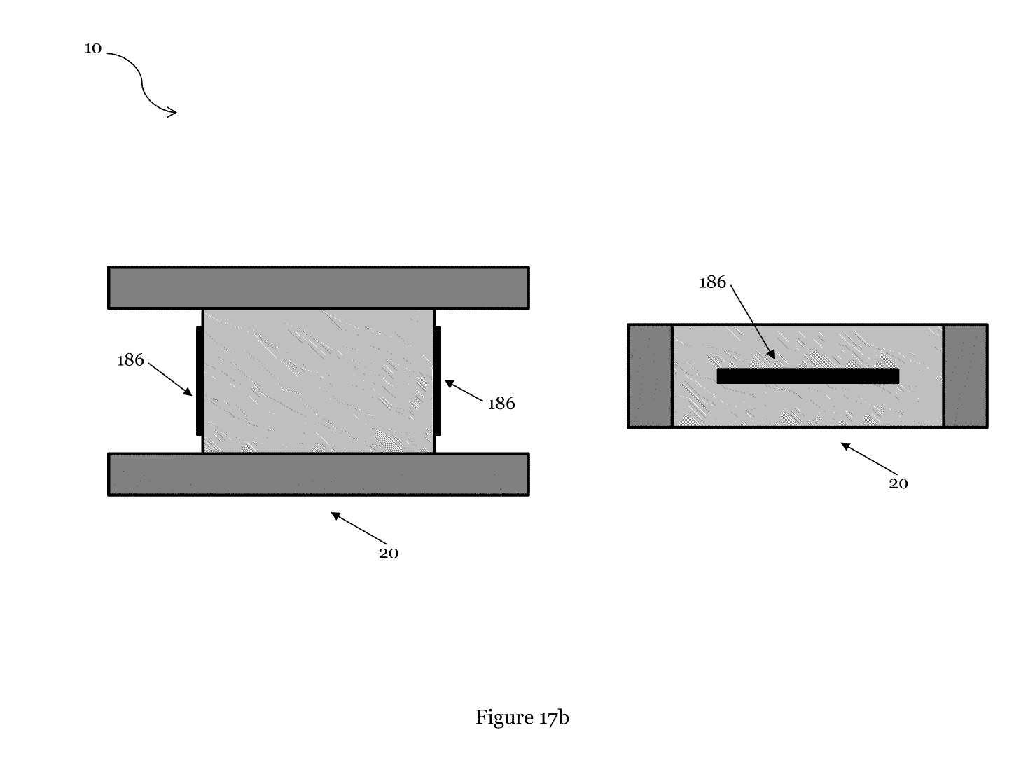

A building can be equipped with robot navigation radio signal emitters or beacons and/or one or more machine-readable inductive or passive signal tags (e.g., RFID tags), which can be attached to objects or locations such as existing doors, existing walls, wall supports, ceiling tiles, underneath floor tiles or carpeting, inside power outlets or conduit, on windows, inside HVAC vents, inside lights, inside network or communication boxes, inside baseboards or crown molding, inside furniture, inside file cabinets, on industrial shelving, inside waste receptacles, or combinations thereof. Protective material can be used on a robot and/or a building, wall, floor, ceiling, door and/or furniture to prevent scuffs and other damage to the robot and/or building, wall, floor, ceiling, door and/or furniture as a robot navigates around a building, and navigation beacons or tags can be embedded within or printed on the protective material, such as a baseboard. As shown in FIG. 17a, a building 300 can be equipped with robot navigation beacons that can provide a robot 20 with information. For example, the information can be for determining current location, direction of travel, an upcoming obstacle and/or turn in a hallway, speed of movement of the robot, the strength of beacon batteries, or combinations thereof.

Robot navigation beacons can include radio frequency emitters at known locations and a robot 20 can use trilateration, triangulation, and/or other suitable methods to calculate its position. For example, a navigation beacon can be a cellular base station 170, a radio broadcasting station 171, a GPS satellite, and/or any other suitable emitter. The robot navigation beacons can be passively emitting Radio Frequency Identification (RFID) tags, or any other suitable passively enabled circuit that requires an antenna to receive an electromagnetic signal and power the circuit, and or re-transmit a response signal.

As shown in FIG. 17a, robot navigation beacons can include sonic emitters and a robot 20 can use sonar to calculate its position; for example, a navigation beacon can be an infrasonic emitter 172, an ultrasonic emitter 173, and/or any other suitable sonic emitter.

As shown in FIG. 17a, robot navigation beacons can include wireless access points and a robot 20 can measure the received signal strength to calculate its position; for example, a navigation beacon can be a wireless router 174, a Bluetooth device, a cellular communications tower, a computer with a wireless Bluetooth or WiFi connection, a wireless repeater, a 3G/4G/LTE radio modem, any type of wireless sensor, laser signals, fiber optics, and/or any other suitable device that provides a wireless connection to a wired network.

As shown in FIG. 17a, robot navigation beacons can include light emitters and a robot 20 can use one or more suitable methods to calculate its position; for example, a navigation beacon can be a visible light emitter, an infrared (IR) emitter 175, and/or any other suitable light emitter.

The robot can be equipped with one or more devices that can detect robot navigation beacons and can include antennas, ultrasonic sensors, WiFi radios, Bluetooth radios, cameras, IR detectors, and/or any other suitable sensor. As shown in FIGS. 17a-1 and FIG. 17a-2, a robot 20 can be equipped with one or more sensor arrays 178, which can include one or more IR detectors 179 and/or any other suitable device, and can be used to enable direction sensitivity. For example, as shown in FIG. 17a-1a and FIG. 17a-1b, a robot 20 can be equipped with a horizontal circular sensor array 178 that can include three or more IR detectors 179-1, 179-2, 179-3. As the robot 20 moves, different pairs of IR detectors 179-1, 179-2, 179-3 will detect wall-mounted robot navigation beacons 175-1, 175-2; the robot can use this information to determine its position and direction of travel. As another example, as shown in FIG. 17a-2a and FIG. 17a-2b, robot navigation beacons 175-3, 175-4 can be mounted on the ceiling 330 and a robot 20 can be equipped with a vertical circular sensor array 178. The robot can be equipped with a camera and can use machine vision to process visual information on a navigation beacon, which can include QR odes, arrows, or other coded visual cues that can direct a robot to turn left, slow down, turn right, watch for other robots crossing, or any other suitable operating instruction.

A robot can use a combination of data from imaging devices, navigation beacons, and/or diagrams of a building to generate a real-time map of a building as it patrols the building performing tasks. A robot can use this technique of simultaneous localization and mapping to avoid obstacles and/or log data that might be important to humans occupying the building; for example, a robot can generate a real-time map of a hallway, compare the current map to a previous map of the hallway, and immediately notice an object on the ground or an area roped off for construction or remodeling. The robot can then avoid the obstacle, capture an image of the object, and relay the image to a remote human who can identify the object and give the robot further instructions.

A robot's interaction with navigation beacons can be recorded on a server. The robot can move from beacon to beacon according to a route command from the server. For example, the robot 20 can detect robot navigation beacons 175-1, 175-2, and this interaction can be transmitted by the robot or the beacon to the server, and analyzed and recorded on a server. The robot can send additional robot performance, audio, video, environmental, and location data to the server optionally along with beacon data transmitted to or sensed by the robot from the beacon. The beacon can transmit data to the server optionally along with robot data transmitted to the beacon. The server can then send (i.e., wired or wirelessly transmit) command or instruction data to the robot, for example, instructing the robot to move to beacon 175-4, replace the battery in beacon 175-2, empty the garbage bin in a nearby room, perform another task, or combinations thereof.

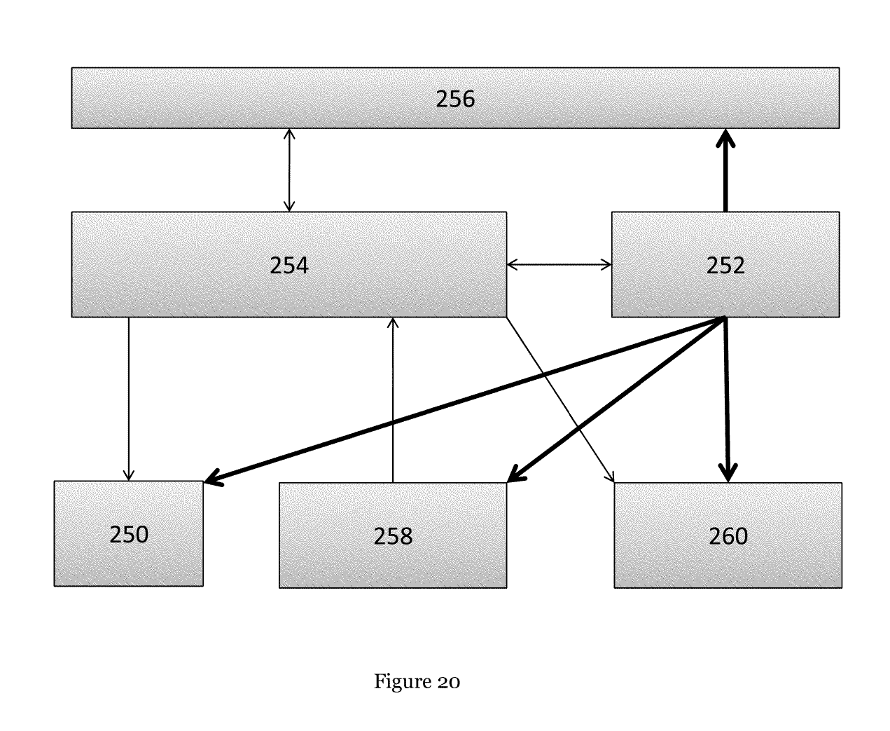

FIG. 20 illustrates that the robot navigation beacons can have one or more visible or infrared lights 250. The lights can turn on to indicate that a robot is nearby. The beacon lights 250 can be used in emergency situations to guide humans toward a building exit.

Robot navigation beacons can be powered using a power source 252 such as one or more batteries, AC power from the wall, and/or any other suitable power supply. The beacons can be turned on and off by the server depending on whether or not there is a robot in the area. For example, if there are no robots in an area surrounding a beacon, a server can turn the beacon off to conserve power. The server can communicate over a wireless or wired connection with the beacon. Beacons can have a wake-on activity function to conserve power. For example a robot can transmit a wakeup signal to all beacons in the vicinity, and the beacons can be awakened and respond with location information, and/or other operating instructions.

The beacons can have a CPU and/or MCU 254, a radio 256, a robot detector 258, and an emitter 260. The radio 256 can be configured to communicate with the server and/or the robots. Signals and power between the components on the beacon can travel in the directions shown by the arrows in FIG. 20.

As shown in FIG. 17a, a building 300 can be equipped with one or more machine-readable tags that can provide a robot 20 with information for performing security checks, safety checks, maintenance tasks, and self-sustainability tasks, and which can include door type, room number, location, when the garbage was last emptied, and the size and layout of a room. Machine-readable tags can provide inputs to the robot, such as instructions for actions, identifications of people or objects, or any other suitable input. Machine-readable tags can include emitters and a robot 20 can receive a signal; for example, a machine-readable tag can be a laser/infrared emitter 181, a sonic emitter 182, and/or any other suitable emitter. (As used herein, beacons can merely be tags.)

As shown in FIG. 17a, machine-readable tags can include displays of encoded information and a robot 20 can process the displayed image; for example, a machine-readable tag can be a quick response (QR) code 183 and/or any other suitable display of encoded information.

As shown in FIG. 17a, machine-readable tags can include devices that store passive identifications linked to a database and a robot 20 can associate the stored identifications with corresponding entries in the database; for example, a machine-readable tag can be a radio-frequency identification (RFID) tag 184, a barcode 185, and/or any other suitable device that stores information.

As shown in FIG. 17b, a robot 20 can be equipped with one or more devices 186 that can read information from machine-readable tags and can include infrared detectors, QR readers, RFID readers, and barcode scanners.

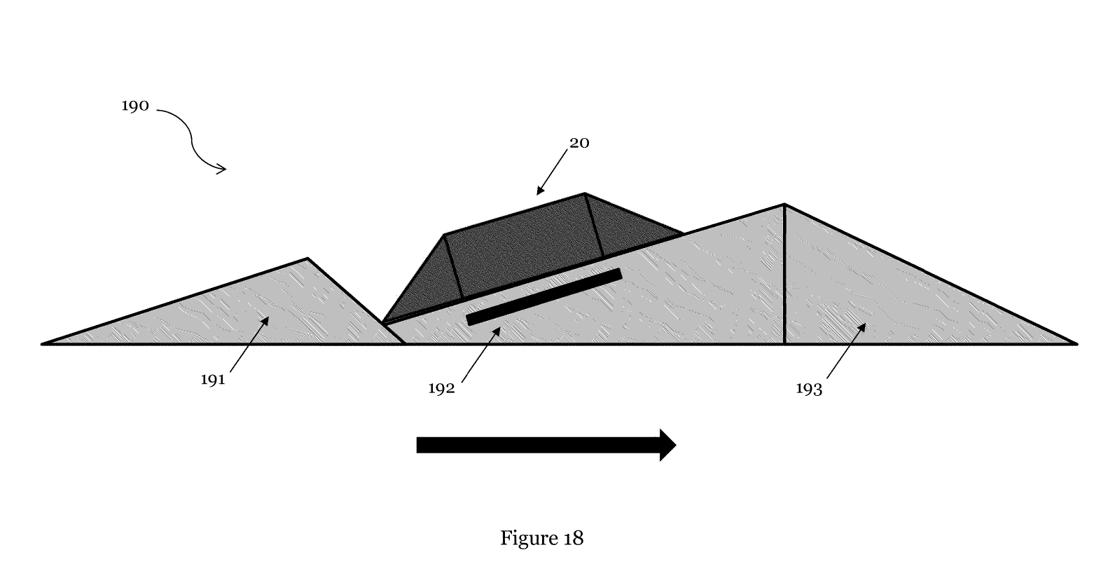

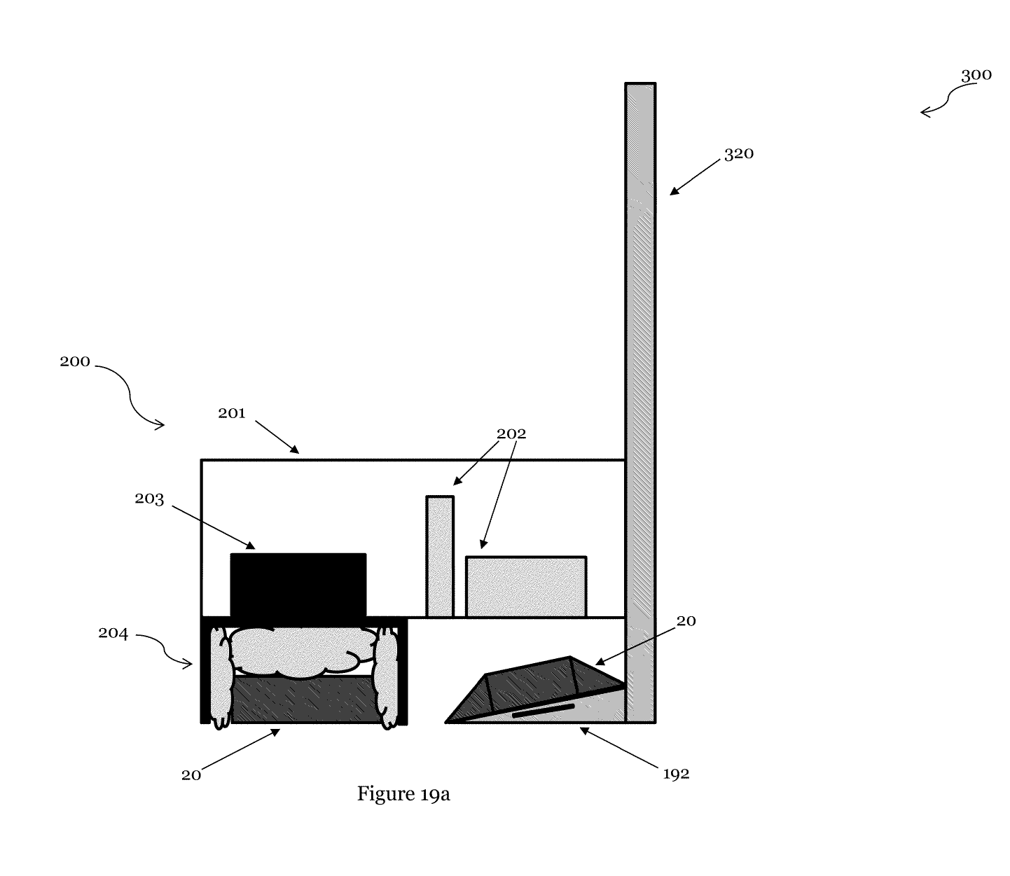

A building can be equipped with one or more robot battery charging stations, which can be disguised to look like cabinets, bookshelves, lockers, furniture, and/or any other suitable object. As shown in FIG. 18, a robot charging station 190 can include an entrance and exit ramps 191 and 193, which can be made of hard plastic, metal, and/or any other suitable material. A robot battery charging station 190 can include a robot battery charger 192, which can be simple, fast, inductive, solar, USB-based, or any other suitable type of battery charger. A robot 20 can use a charging station 190 to recharge its battery; for example, a robot 20 can drive up the entrance ramp 191, settle into an appropriate position above an inductive charger 192, and drive down the exit ramp 193 when its battery is fully charged.

Alternatively, a robot can be equipped with a solar charger and can park in a designated sunlit area to recharge; for example, a robot can park outside of the building, on the roof, on a balcony, next to an open window, or in any other suitable location.

Alternatively, robot batteries can be mechanically swapped out and charged separately, or a non-rechargeable battery can be replaced, and a robot can make sure it has enough batteries in a battery magazine. In a situation where a battery magazine runs low, a robot can phone in an order for more batteries from a supplier or human maintenance worker and possibly receive the batteries from a shipping service or human worker and restock the battery magazine by itself.

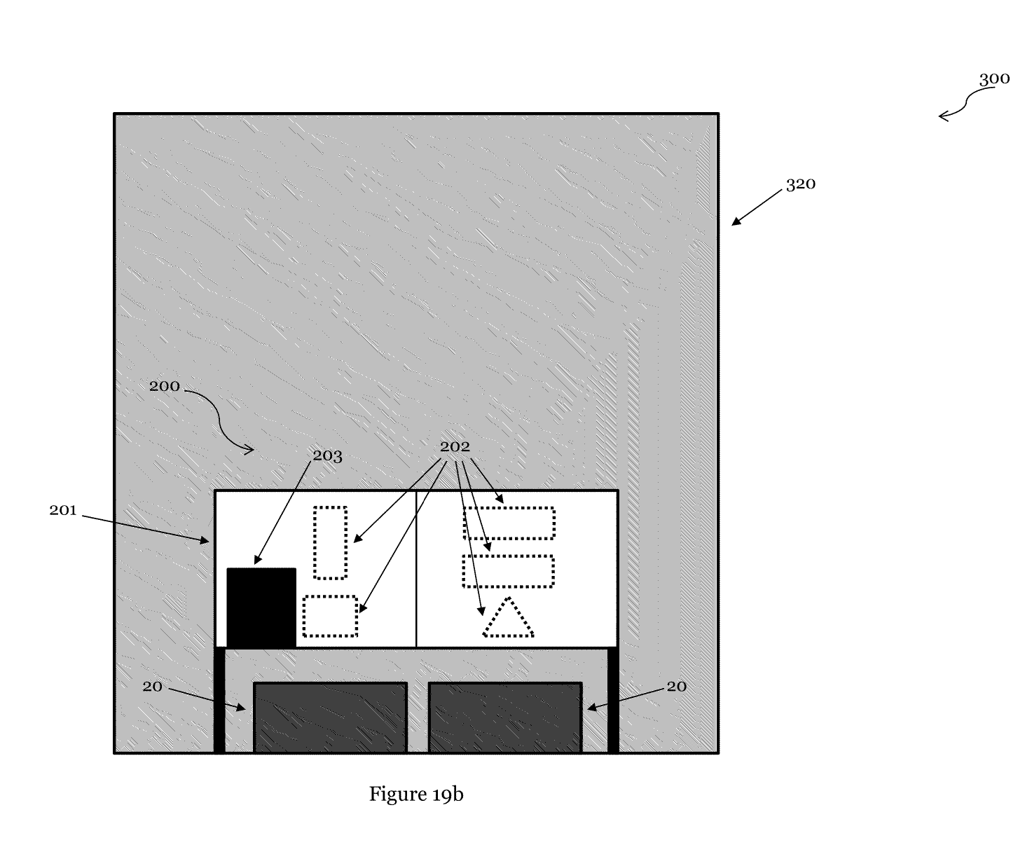

A building can be equipped with one or more robot accessory changing stations, which can be disguised to look like cabinets, bookshelves, lockers, furniture, and/or any other suitable object. As shown in FIGS. 19a and 19b, a building 300 can be equipped with a robot accessory changing station 200, which can allow a robot 20 to adapt its functionality with different payloads 202. A robot accessory changing station 200 can contain one or more accessories 202, which can include a utility arm 30, jointed arm 80, access cards, keys, and magnets. A robot payload station 200 can include a waste receptacle 203 where a robot 20 can empty trash cans and vacuum bags. A robot payload station 200 can include a robot cleaning system 204 and a robot 20 can drive through a robot cleaner 205 to be cleaned. A robot payload station 200 can include a robot battery charger 192, and a robot 20 can park near an inductive charger to recharge its battery. Alternatively, a payload station 200 can include a magazine of robot batteries and a robot 20 can exchange and/or replace its battery.

Robots, elements, and methods described in U.S. Pat. No. 8,100,205, issued Jan. 24, 2012 and U.S. patent application Ser. No. 13/740,928, filed Jan. 14, 2013 are incorporated by reference herein.

As a person skilled in the art will recognize from the previous detailed description and from the figures and claims, modifications, changes and combinations of disclosed elements and methods can be made to the variations disclosed without departing from the scope of the disclosure.

We claim:

1. A robot beacon navigation system comprising:
a building comprising two robot navigation beacons and/or tags at different locations in the building;
a server;
a mobile robot configured to wirelessly communicate directly or indirectly with the server, and wherein the robot is configured to receive a signal from the beacons and/or tags;
wherein the robot is configured to send the signal received from the beacons and/or tags to the server, and wherein the server is configured to send instruction data to the robot in response to the signal received from at least one of the beacons and/or tags.

2. A method of controlling a mobile robot comprising:
positioning the robot in a building comprising two robot navigation beacons and/or tags at different locations in the building;
transmitting beacon data from the beacons and/or tags to the robot;
transmitting robot data from the robot to a server, wherein the robot data comprises at least a portion of the beacon data; and
transmitting instruction data from the server to the robot.

3. The method of claim 2, wherein instruction data comprises data including the location of the robot with respect to the building.

4. The method of claim 2, wherein the instruction data comprises instructions for the robot to perform a task.

5. A method of moving a robot through a doorway comprising:
closing a door in the doorway, wherein the door comprises an upper partition and a lower partition;
opening the lower partition with the robot while the upper partition remains closed; and
traversing the doorway with the robot.

6. The method of claim 5, wherein the lower partition is segmented

7. The method of claim 5, wherein opening comprises rotating the lower partition with respect to the upper partition.

8. The method of claim 5, wherein opening comprises sliding the lower partition up;

9. The method of claim 8, wherein opening comprises sliding the lower partition into the upper partition.

10. The method of claim 8, wherein opening comprises sliding the lower partition adjacent to and outside of the upper partition.

11. The method of claim 5, wherein opening comprises sliding the lower partition down.

12. The method of claim 5, wherein opening comprises forcing the lower partition along a curved track.

13. The method of claim 5, wherein opening comprises sensing a signal emitted from the robot.

14. The method of claim 5, wherein opening comprises turning a key by the robot.

15. The method of claim 5, wherein opening comprises pressing a button on the door by the robot.

16. The method of claim 5, wherein opening comprises pulling on a handle on the door by the robot.

17. A door comprising:
an upper partition and a rigid lower partition;
wherein the lower partition is configured to rotate with respect to the upper partition; and
an actuator configured to unlock the lower partition, wherein the actuator is configured to be activated by a mobile robot.

18. The door of claim 17, wherein the upper partition is configured to remain closed when the lower partition opens.

19. The door of claim 17, wherein the actuator is configured to be activated by a mobile robot moving near the door.

20. The door of claim 17, wherein the actuator is configured to open the door.
